(19) United States
(12) Patent Application Publication
(10) Pub. No.: US 2016/0085768 A1
(43) Pub. Date: Mar. 24, 2016

(54) INFORMATION PROCESSING SYSTEM, AND INFORMATION PROCESSING METHOD

(71) Applicant: Takahiro HASHIMOTO, Kanagawa (JP)

(72) Inventor: Takahiro HASHIMOTO, Kanagawa (JP)

(73) Assignee: RICOH COMPANY, LTD., Tokyo (JP)

(21) Appl. No.: 14/840,264

(22) Filed: Aug. 31, 2015

(30) Foreign Application Priority Data
Sep. 24, 2014 (JP) 2014-194029

(51) Int. Cl. G06F 17/30

(52) U.S. Cl. CPC G06F 17/30165; G06F 17/30598; G06F 17/30194

(57) ABSTRACT

An information processing system includes first and second information processing terminals; and an information processing device that is connected to the first and second information processing terminals. The information processing system includes a receiver for receiving message data and file specifying data for specifying a file that are transmitted from the first and second information processing terminals; a storage unit for classifying the file that is specified by the file specifying data based on access right data representing access rights that are set for users of the first and second information processing terminals and classification data, and for storing the classified file; and a transmitter for transmitting, to the first or second information processing terminal, the message data that is received by the receiver and message data that includes file storage data that represents the file that is stored in the storage unit.

### BACKGROUND OF THE INVENTION

1. Field of the Invention

The present invention relates to an information processing system, and an information processing method.

2. Description of the Related Art

A method has been known in the past that is for sharing data by using a file management server.

Specifically, a method has been known such that, for sharing a file among a plurality of users, a request classification level is shared among the users, and uploading is restricted based on the shared request classification level (cf. Patent Document 1 (Japanese Unexamined Patent Publication No. 2011-253483), Patent Document 2 (Japanese Unexamined Patent Publication No. 2010-92455), and Patent Document 3 (Japanese Patent No. 4557658), for example).

### SUMMARY OF THE INVENTION

However, in the known method, a file server or the like may not store a classification setting of a file and the file that is to be shared based on access rights of users. Thus, tasks may arise such that a user notifies other users of a location where the file to be shared is stored. Consequently, a workload for the user can be increased.

There is a need for reducing a workload for a user for sharing a file.

According to an aspect of the present invention, there is provided an information processing system including at least a first information processing terminal; a second information processing terminal; and an information processing device that is connected to the first information processing terminal and to the second information processing terminal. The information processing system includes a receiver configured to receive message data and file specifying data for specifying a file, the message data and the file specifying data being transmitted from the first information processing terminal and/or the second information processing terminal; a storage unit configured to classify the file that is specified by the file specifying data based on access right data that represents access rights that are set for a user of the first information processing terminal and a user of the second information processing terminal, respectively, and classification data that represents classification, and configured to store the classified file; and a transmitter configured to transmit, to the first information processing terminal or the second information processing terminal, the message data that is received by the receiver and message data that includes file storage data that represents the file that is stored in the storage unit.

According to another aspect of the present invention, there is provided an information processing method that is to be executed by an information processing system including at least a first information processing terminal; a second information processing terminal; and an information processing devices that is connected to the first information processing terminal and to the second information processing terminal. The method includes a receiving step of receiving, by the information processing device, message data and file specifying data for specifying a file, the message data and the file specifying data being transmitted from the first information processing terminal and/or the second information processing terminal; a storing step, by the information processing device, of classifying the file that is specified by the file specifying data based on access right data that represents access rights that are set for a user of the first information processing terminal and a user of the second information processing terminal, respectively, and classification data that represents classification, and storing the classified file; and a transmitting step, by the information processing device, of transmitting, to the first information processing terminal or the second information processing terminal, the message data that is received at the receiving step and message data that includes file storage data that represents the file that is stored at the storing step.

According to an embodiment of the present invention, a workload for a user for sharing a file can be reduced.

Other objects, features and advantages of the present invention will become more apparent from the following detailed description when read in conjunction with the accompanying drawings.

### BRIEF DESCRIPTION OF THE DRAWINGS

FIG. 1 is a diagram showing an example of an overall configuration of an information processing system according to an embodiment of the present invention;

FIG. 2 is a block diagram showing an example of a hardware configuration of an information processing terminal according to the embodiment of the present invention;

FIG. 3 is a block diagram showing an example of a hardware configuration of an information processing device according to the embodiment of the present invention;

FIG. 4 is a functional block diagram showing an example of a functional configuration of the information processing terminal according to the embodiment of the present invention;

FIG. 5 is a functional block diagram showing an example of a functional configuration of the information processing device according to the embodiment of the present invention;

FIG. 6 is an image diagram showing an example of a Web UI that displays a two-dimensional code;

FIG. 7 is an image diagram showing an example of a screen for reading the two-dimensional code;

FIG. 8 is a diagram showing an example of information that is retrieved from the two-dimensional code;

FIG. 9 is a flowchart of an example of a smart device registration process;

FIG. 10 is an image diagram showing an example of a screen showing a success;

FIG. 11 is a sequence diagram showing an example of an overall process by the information processing system according to the embodiment of the present invention;

FIG. 12 is a sequence diagram showing an example of various types of setting by the information processing system according to the embodiment of the present invention;

FIG. 13 is an image diagram showing an example of a group creation screen;

FIG. 14 is an image diagram showing an example of a classification setting screen;

FIG. 15 is a diagram showing an example of a process of creating a folder as a storage of a server according to the embodiment of the present invention;

FIG. 16 is an image diagram showing an example of a screen for selecting a chat group;

FIG. 17 is an image diagram showing an example of a chat screen;

FIG. 18 is an image diagram showing an example of a file selection screen;

FIG. 19 is an image diagram showing an example of the chat screen that displays a content of a file;

FIG. 20 is a sequence diagram showing an example of a process that is executed when the information processing system according to the embodiment of the present invention uploads a file;

FIGS. 21A and 21B are diagrams showing an example of an operation screen according to the embodiment of the present invention that is for uploading a file;

FIGS. 22A and 22B are diagrams showing an example of message data according to the embodiment of the present invention that includes file storage data;

FIG. 23 is a flowchart showing an example of entire processes by the devices according to the embodiment of the present invention;

FIG. 24 is a diagram showing an example of a method of sharing a file according to related art;

FIGS. 25A-25D are diagrams showing an example of an effect of the process by the information processing system according to the embodiment of the present invention;

FIG. 26 is a diagram showing an example of an overall configuration of an information processing system according to another embodiment of the present invention;

FIG. 27 is a block diagram showing an example of an effect of the information processing system according to the other embodiment of the present invention;

FIG. 28 is a functional block diagram showing an example of a functional configuration of a chat server according to the embodiment of the present invention;

FIG. 29 is a functional block diagram showing an example of a functional configuration of a relay server according to the embodiment of the present invention; and

FIG. 30 is a functional block diagram showing an example of a functional configuration of a file storage according to the embodiment of the present invention.

### DETAILED DESCRIPTION OF THE PREFERRED EMBODIMENTS

Hereinafter, there is explained an information processing system and an information processing method according to an embodiment of the present invention.

### Embodiment

<System configuration>

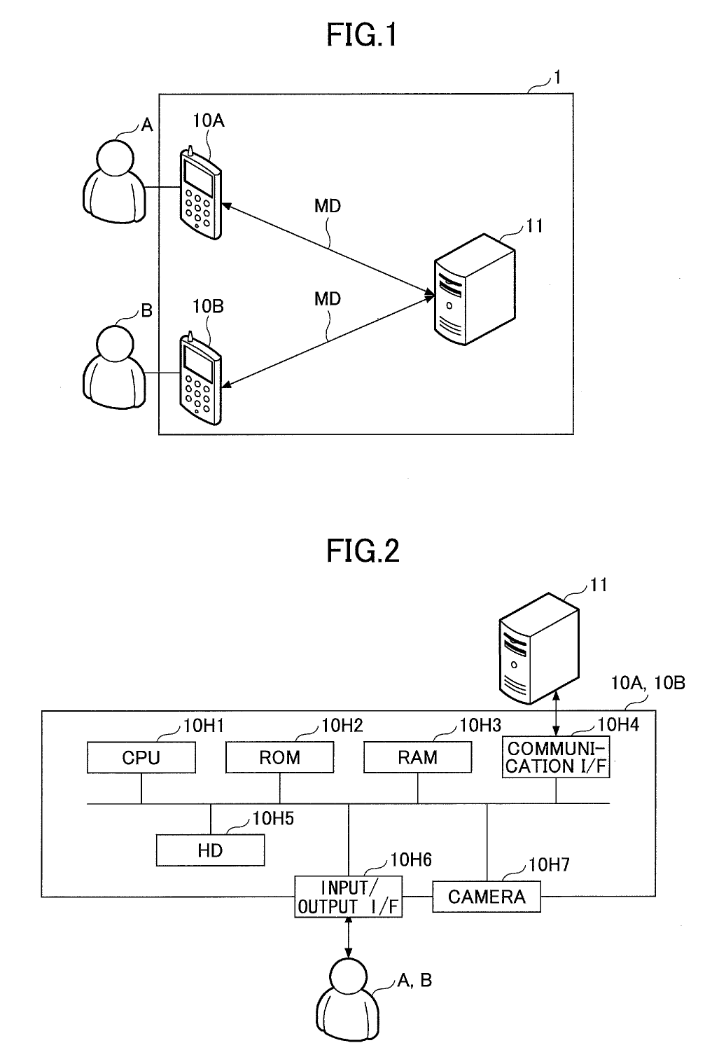

FIG. 1 is a diagram showing an example of an overall configuration of an information processing system according to an embodiment of the present invention.

The information processing system 1 may include a first information processing terminal 10A; a second information processing terminal 10B; and a server 11. In FIG. 1, a case is explained in which, in the information processing system 1, an information processing terminal that is to be used by a user A is the first information processing terminal 10A, and an information processing terminal that is to be used by a user B is the second information processing terminal 10B. As depicted in FIG. 1, the server 11 is connected to the first information processing terminal 10A and to the second information processing terminal 10B. The server 11 can transmit message data MD to the first information processing terminal 10A, and can receive message data MD from the first information processing terminal 10A. Similarly, the server 11 can transmit message data MD to the second information processing terminal 10B, and can receive message data MD from the second information processing terminal 10B.

The first information processing terminal 10A and the second information processing terminal 10B can perform communication, such as so-called “chatting (chat),” where messages are exchanged between users by transmitting and receiving message data MD via the server 11. Note that the information processing system 1 is not limited to the case where the two information processing terminals are included. The information processing system 1 may include more than two information processing terminals.

<Hardware Configuration>

FIG. 2 is a block diagram showing an example of a hardware configuration of the information processing terminal (10A/10B) according to the embodiment of the present invention.

The first information terminal 10A can be a smartphone, for example. Alternatively, the first information processing terminal 10A may be a tablet, a personal computer (PC), or a mobile PC. Similarly, the second information processing terminal 10B can be a smartphone, for example. Alternatively, the second information processing terminal 10B may be a tablet, a personal computer (PC), or a mobile PC. Hereinafter, a case is explained in which the first information processing terminal 10A is a smartphone, and the second information processing terminal 10B is a smartphone. In the following, the explanation is provided by exemplifying the first information processing terminal 10A, and the explanation of the second information processing terminal B is omitted.

The first information processing terminal 10A may include a central processing unit (CPU) 10H1; a read-only memory (ROM) 10H2; and a random access memory (RAM) 10H3. Additionally, the first information processing terminal 10A may include a communication interface (I/F) 10H4; a hard disk (HD) 10H5; an input/output interface (I/F) 10H6; and a camera 10H7. The hardware components that are included in the first information processing terminal 10A can be mutually connected through a bus, so that the hardware components can mutually transmit and receive data or the like.

The CPU 10H1 can be a processor and a controller that can implement various types of processes that can be executed by the first information processing terminal 10A by reading out a program, data, or the like from a storage device, such as the ROM 10H2 and the HD 10H5, by writing the program, the data or the like in the RAM 10H3, and by executing the program.

The ROM 10H2 can be a storage device, such as a non-volatile semiconductor memory, that can maintain a program, data, and the like that are stored therein, even if the power supply is turned off. In response to activation of the first information processing terminal 10A, the ROM 10H2 can store firmware or the like that is to be executed, such as the Basic Input/Output System (BIOS). The ROM 10H2 can store settings of an Operating System (OS), data of network settings, a program, and so forth.

The RAM 10H3 can be a main storage device, such as a volatile semiconductor memory, that can maintain a program, data, and so forth.

The communication I/F 10H4 can be an interface for connecting the first information processing terminal 10A to a network. The communication I/F 10H4 may be an antenna, a processing integrated circuit (IC), or a driver, for example. The communication I/F 10H4 can communicate data between the first information processing terminal 10A and an external device, such as the server 11, through the network.

The HD 10H5 can be an auxiliary storage device for storing a program, data, and the like. The HD 10H5 can store a program, such as the OS that is a system software for controlling the entire first information processing terminal 10A, and application software that provides various types of functions on the OS.

The input/output I/F 10H6 can be an input device for inputting various types of operations, by the user A, with respect to the first information processing terminal 10A. At the same time, the input/output I/F 10H6 can be an output device for displaying, for example, a processing result that is processed by the first information processing terminal 10A. The input/output I/F 10H6 may be a touch panel, for example. Note that the input/output I/F 10H6 can be implemented by combining an input device, such as a keyboard, and an output device, such as a display.

The camera 10H7 can capture a still picture and/or a motion picture based on an operation by the user A, and the camera 10H7 can generate image data. The camera 10H7 can be implemented by an optical component, such as a lens, an optical sensor, and an image processing IC, for example.

Note that the hardware configurations of the information processing terminals 10A and 10B are not limited to the configuration that is shown in FIG. 2. For example, each of the hardware configurations of the information processing terminals 10A and 10B may include a device for assisting the hardware components that are included in the information processing terminal.

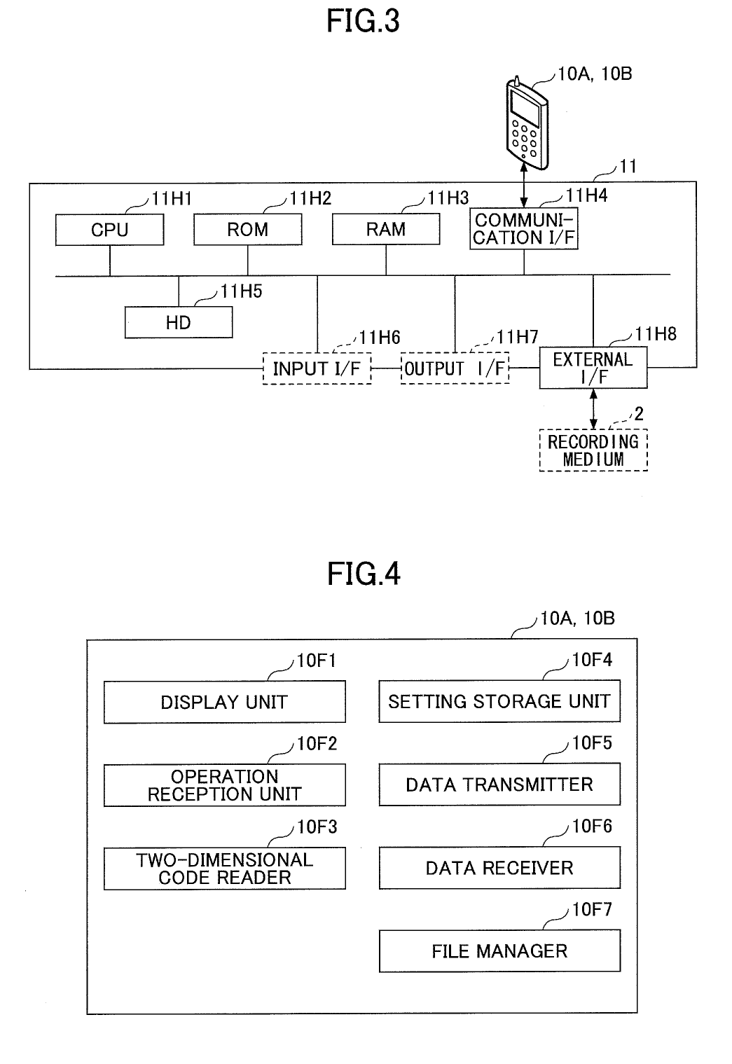

FIG. 3 is a block diagram showing an example of a hardware configuration of the information processing device according to the embodiment of the present invention.

The information processing device can be the server 11, for example. Hereinafter, a case is explained in which the information processing device is the server 11.

The server 11 may include a CPU 11H1; a ROM 11H2; a RAM 11H3; a communication I/F 11H4; an HD 11H5; an input I/F 11H6; an output I/F 11H7; and an external I/F 11H8. The hardware components that are included in the server 11 can be mutually connected by a bus, so that the hardware components can mutually communicate data or the like.

The CPU 11H1 can be a processor and a controller that can implement various types of processes that can be executed by the server 11 by reading out a program, data, or the like from a storage device, such as the ROM 11H2 and the HD 11H5, by writing the program, the data or the like in the RAM 11H3, and by executing the program.

The ROM 11H2 can be a storage device, such as a non-volatile semiconductor memory, that can maintain a program, data, and the like that are stored therein, even if the power supply is turned off. In response to activation of the server 11, the ROM 11H2 can store firmware or the like that is to be executed, such as the BIOS. The ROM 11H2 can store settings of an OS, data of network settings, a program, and so forth.

The RAM 11H3 can be a main storage device, such as a volatile semiconductor memory, that can maintain a program, data, and so forth.

The communication I/F 11H4 can be an interface for connecting the server 11 to a network. The communication I/F 11H4 may be a connector, a communication cable, a processing IC, or a driver, for example. The communication I/F 11H4 can communicate data between the server 11 and an external device, such as the first information processing terminal 10A and the second information processing terminal 10B, through the network.

The HD 11H5 can be an auxiliary storage device for storing a program, data, and the like. The HD 11H5 can store a program, such as the OS that is a system software for controlling the entire server 11, and application software that provides various types of functions on the OS.

The input I/F 11H6 can be an input device for inputting various types of operations with respect to the server 11. The input I/F 11H6 can be implemented by a keyboard, a mouse, a touch panel, or the like.

The output I/F 11H7 can be an output device for displaying, for example, a processing result that is processed by the server 11. The output I/F 11H7 can be implemented by a display, for example.

Here, the input device and the output device may be devices that can be detachably attached to the server 11.

The external I/F 11H8 is an interface to a recording medium 2 or the like. The recording medium 2 can be an optical medium, such as a Compact Disc-Read Only Memory (CD-ROM), or a Universal Serial Bus (USB) memory, for example. The server 11 can input data or the like to the recording medium 2 through the external I/F 11H8, and the server 11 can read out data or the like from the recording medium 2 through the external I/F 11H8. The external I/F 11H8 can be implemented by a connector and a processing IC, for example.

Note that the hardware configuration of the information processing device is not limited to the configuration that is shown in FIG. 3. For example, the hardware configuration of the information processing device may include a device for assisting the hardware components that are included in the information processing device. Note that the information processing system 1 is not limited to the case where only one information processing device is included. For example, the information processing device may be formed of two or more information processing devices that are connected by a network or the like.

The information processing terminal can cause an external device that is connected to the information processing terminal through a network to execute, in parallel, in a distributed manner, or in a redundant manner, a part of or all the process that is to be executed by the information processing terminal. Similarly, the information processing device can cause an external device that is connected to the information processing device through a network to execute, in parallel, in a distributed manner, or in a redundant manner, a part of or all the process that is to be executed by the information processing device.

<Functional Configuration>

FIG. 4 is a functional block diagram showing an example of a functional configuration of the information processing terminal according to the embodiment of the present invention.

Each of the first information processing terminal 10A and the second information processing terminal 10B may have a functional configuration, such as depicted in FIG. 4. Hereinafter, a case is explained in which the information processing terminal is the first information processing terminal 10A.

The first information processing terminal 10A may include a display unit 10F1; an operation reception unit 10F2; a two-dimensional code reader 10F3; a setting storage unit 10F4; a data transmitter 10F5; a data receiver 10F6; and a file manager 10F7. In the first information processing terminal 10A, each function can be implemented by executing application software that is stored in the first information processing terminal 10A, for example.

The display unit 10F1 can display, to the user A, a content of a file, a content of chat conversation with the user B, and a file selection screen or the like by text, an image, a Graphical User Interface (GUI), for example. The display unit 10F1 can be implemented by the input/output I/F 10H6, for example.

The operation reception unit 10F2 can receive various types of operations from the user A. The operation reception unit 10F2 can be implemented by the input/output I/F 10H6, for example.

The two-dimensional code reader 10F3 can read a two-dimensional code, such as Quick Response Code (QR code) (registered trademark). The two-dimensional code reader 10F3 can be implemented by the camera 10H7, for example.

The setting storage unit 10F4 can store various types of settings, such as a user name, a password, or a group. The setting storage unit 10F4 can be implemented by the HD 10H5, for example.

The data transmitter 10F5 can transmit message data that represents a content of chat conversation that is input to the first information processing terminal 10A by the user A and data, such as various types of files, to the server 11, and to an external device, such as the second information processing terminal 10B, through the server 11. The data transmitter 10F5 can be implemented by the communication I/F 10H4, for example.

The data receiver 10F6 can receive message data that represents a content of chat conversation that is transmitted to the first information processing terminal 10A and various types of files or the like from an external device, such as the server 11. The data receiver 10F6 can be implemented by the communication I/F 10H4, for example.

The file manager 10F7 can store and discard caches of, for example, various types of files that are received by the first information processing terminal 10A. The file manager 10F7 can be implemented by the CPU 10H1, for example.

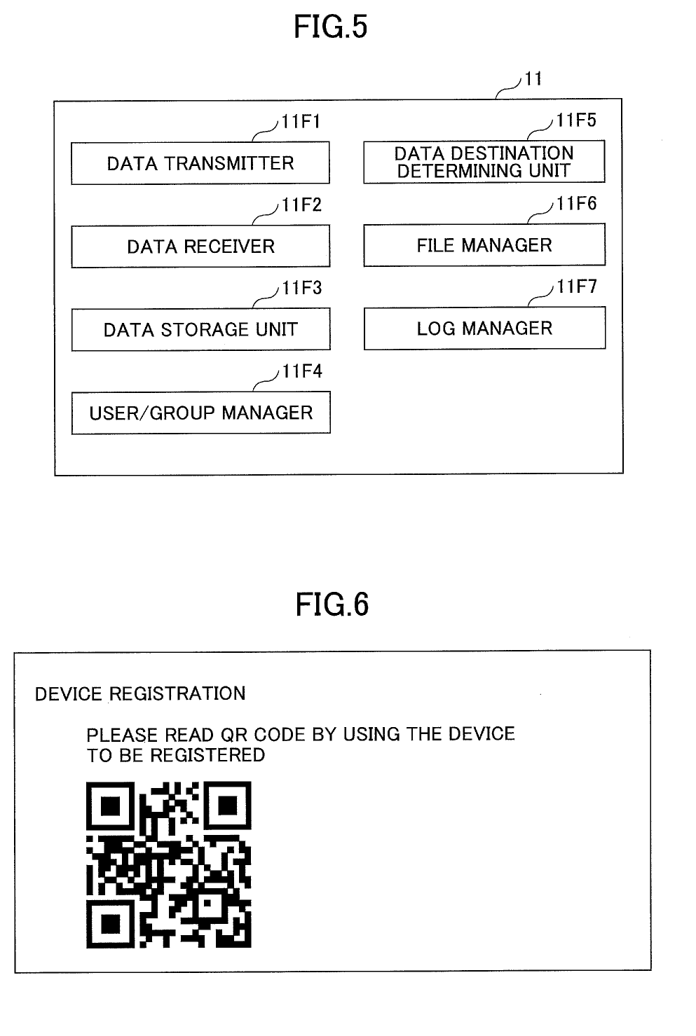

FIG. 5 is a functional block diagram showing an example of a functional configuration of the information processing device according to the embodiment of the present invention.

The server 11 may include a data transmitter 11F1; a data receiver 11F2; a data storage unit 11F3; a user/group manager 11F4; a data destination determining unit 11F5; a file manager 11F6; and a log manager 11F7.

The data transmitter 11F1 can transmit message data and data, such as various types of files, to an external device, such as the first information processing terminal 10A and the second information processing terminal 10B. The data transmitter 11F1 can be implemented by the communication I/F 11H4, for example.

The data receiver 11F2 can receive message data and data, such as various types of files, from an external device, such as the first information processing terminal 10A and the second information processing terminal 10B. The data receiver 11F2 can be implemented by the communication I/F 11H4, for example.

The data storage unit 11F3 can store message data and data, such as various types of files, that are received by the data receiver 11F2. The data storage unit 11F3 can be implemented by the HD 11H5, for example.

The user/group manager 11F4 can manage, for example, for a case of chatting, a user who is to be participated in the chat and a group to which message data representing a content of chat conversation is to be transmitted. Additionally, the user/group manager 11F4 can manage classification setting of a folder of a group. The user/group manager 11F4 can be implemented by the CPU 11H1, for example.

The data destination determining unit 11F5 can determine a group which is to be a destination of transmission of message data that represents a content of chat conversation. The data destination determining unit 11F5 can be implemented by the CPU 11H1, for example.

The log manager 11F7 can store a log during chatting, for example. The log manager 11F7 can be implemented by the CPU 11H1 and the HD 11H5, for example.

The log manager 11F7 can store a log during chatting, for example. The log manager 11F7 can be implemented by the CPU 11H1 and the HD 11H5, for example.

<Registration of a Device>

In the information processing system 1, an information processing terminal or the like that is registered to the information processing system 1 can access the server 11. For example, in the information processing system 1, the first information processing terminal 10A or the like that can access the server 11 is registered (paired) by using the two-dimensional code in the following manner. Hereinafter, the registration process for registering a device to the information processing system 1 is explained by exemplifying a case in which the first information processing terminal 10A is registered to the information processing system 1.

FIG. 6 is an image diagram of an example of a Web UI on which the two-dimensional code is displayed.

A two-dimensional code, such as QR code (registered trademark) is displayed on the Web User Interface (UI) that is shown in FIG. 6. A user causes the first information processing terminal 10A that is to be registered as the first information processing terminal 10A that is allowed to access the server 11 to read the two-dimensional code that is displayed on the Web UI.

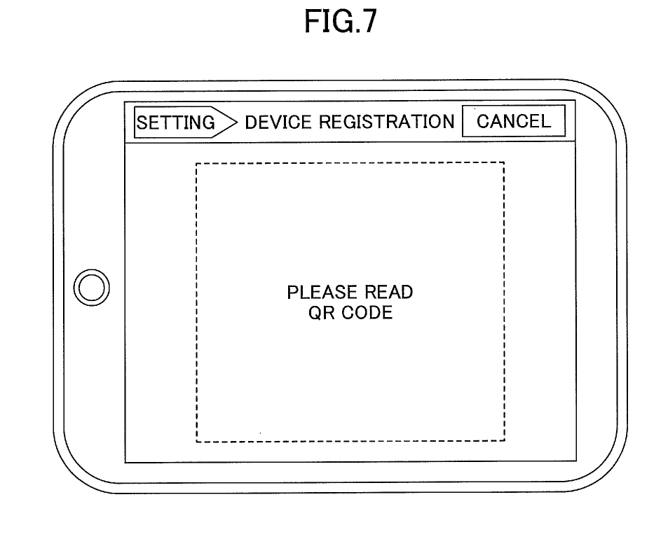

FIG. 7 is an image diagram of an example of a screen for reading the two-dimensional code.

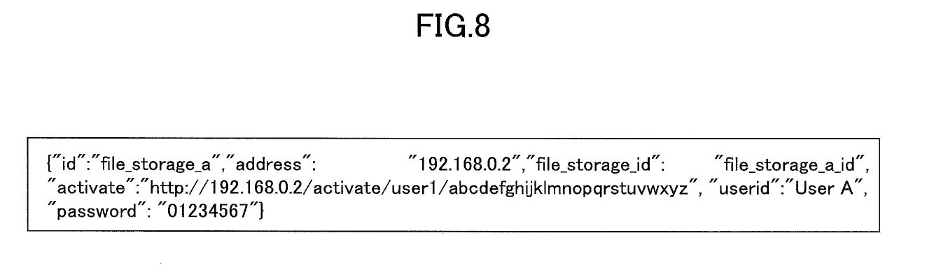

For example, a user adjust the position of the first information processing terminal 10A, so that the captured two-dimensional code is displayed inside the dotted line of the screen that is shown in FIG. 7. In this manner, the user can cause the first information processing terminal 10A to read the two-dimensional code. Note that registration of the first information processing terminal 10A is to be executed, regardless of whether accessing is via a relay server or not. By reading the two-dimensional code, the first information processing terminal 10A can retrieve the information that is required for accessing the server 11, such as shown in FIG. 8. The first information processing terminal 10A can capture the two-dimensional code by using the camera 10H7, for example.

Note that the Web UI that is shown in FIG. 6 can be displayed on the terminal device by accessing an information processing server, such as the server 11, from the terminal device that is operated by a user. Alternatively, the two-dimensional code may be printed on a paper sheet, and the printed two-dimensional code may be used.

FIG. 8 is a diagram showing an example of the information that can be retrieved from the two-dimensional code.

FIG. 8 shows an example of the information that may be required for accessing the server 11. FIG. 8 shows a case in which server 11 specific identification (ID), an Internet Protocol (IP) address, ID that is to be used for accessing via the relay server, and a link that is to be used for activation are included in the information that is retrieved from the two dimensional code.

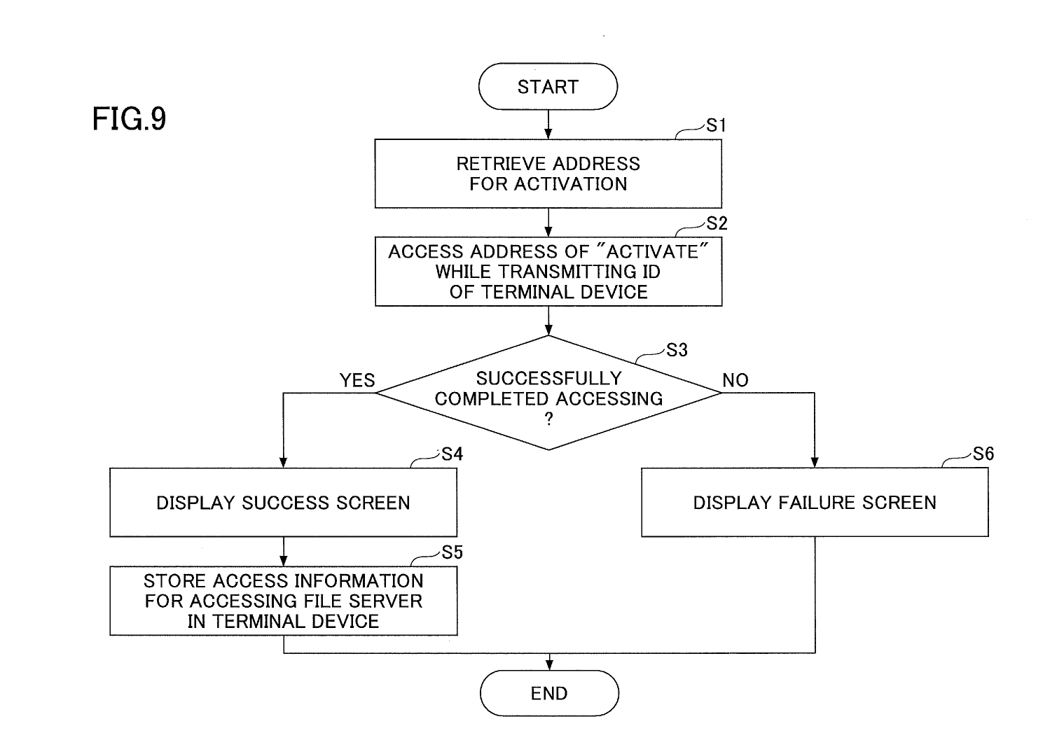

FIG. 9 is a flowchart showing an example of a smart device registration process.

At step S1, the first information processing terminal 10A retrieves a link that is used for activation (the example of the link is shown in FIG. 8) from the two-dimensional code that is shown in FIG. 6, for example.

At step S2, the first information processing terminal 10A transmits smart device ID of the first information processing terminal 10A, and the first information processing terminal 10A accesses a link (an address for activation) that is used for activation.

At step S3, the first information processing terminal 10A accesses the link that is used for the activation, and the first information processing terminal 10A determines whether the registration of the first information processing terminal 10A to the server 11 is successfully completed. After accessing the link that is used for activation, upon determining that the registration of the first information processing terminal 10A to the server 11 is successfully completed (YES at step S3), the first information processing terminal 10A proceeds to step S4. After accessing the link that is used for activation, upon determining that the registration of the first information processing terminal 10A to the server 11 has been failed (NO at step S3), the first information processing terminal 10A proceeds to step S6.

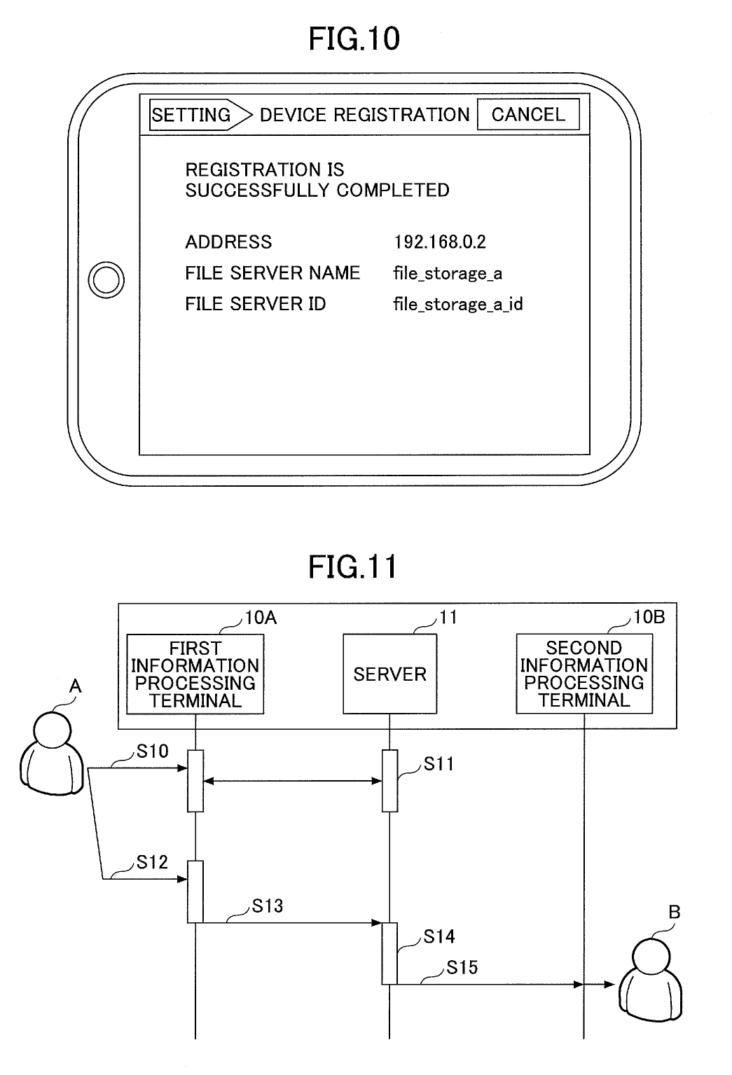

At step S4, the first information processing terminal 10A displays a success screen. After accessing the link that is used for activation, and upon determining that the registration of the first information processing terminal 10A to the server 11 is successfully completed, the first information processing terminal 10A displays a success screen, such as shown in FIG. 10, at step S4.

FIG. 10 is an image diagram of an example of the success screen.

The success screen that is shown in FIG. 10 can display that the registration of the first information processing terminal 10A to the server 11 is successfully completed; an IP address of the server 11 to which the first information processing terminal 10A is registered; a server name of the server 11; server ID of the server 11; and so forth. After completing step 4, the first information processing terminal 10A proceeds to step S5.

At step S5, the first information processing terminal 10A stores information that may be required for accessing the file server 14 (information for accessing the file server 14) in the first information processing terminal 10A.

At step S6, the first information processing terminal 10A displays a failure screen. In response to detecting that the registration of the first information processing terminal 10A to the server 11 has been failed at step S3, the first information processing terminal 10A displays the failure screen at step S6.

The flowchart that is shown in FIG. 9 shows a flow such that the information processing system 1 executes activation based on an address for the activation that is retrieved from the two-dimensional code. Namely, the flowchart that is shown in FIG. 9 shows a flow such that the information processing system 1 registers information on the first information processing terminal 10A to the server 11, and that the information processing system 1 registers information on the server 11 to the first information processing terminal 10A.

The server 11 disallows an information processing terminal that does not execute the smart device registration process that is shown in FIG. 9 to access the server 11. For accessing the server 11 from an information processing terminal, the information processing terminal can be required to execute the smart device registration process that is shown in FIG. 9. The information processing terminal 10A that has executed the smart device registration process can be allowed to retrieve data, such as various types of files, that is stored in the server 11.

<Overall Process>

FIG. 11 is a sequence diagram showing an example of an overall process that is to be executed by the information processing system 1 according to the embodiment of the present invention.

The information processing system 1 can execute setting on access rights of users, setting on groups, and setting on classification. Upon a file or the like being uploaded during chatting, the information processing system 1 can classify and store the uploaded file or the like, based on the settings on the access rights, the groups, and classification.

FIG. 11 shows an example in which various types of settings, such as the setting on the access rights, the setting on the groups, and the setting on the classification, can be made by the user A by operating the first information processing terminal 10A. Note that the various types of settings, such as the setting on the group and the setting on the classification can be made from another information processing terminal. Here, the user who makes the various types of settings is not limited to the user A. The various types of settings may be made by an administrator of the information processing system 1, for example. Hereinafter, the process of FIG. 11 is explained by exemplifying a case in which the various types of the settings are made by the user A by operating the first information processing terminal 10A.

At step S10, the user A makes an operation for inputting various types of settings, such as the setting on the access rights, the setting on the groups, and the setting on the classification, to the first information processing terminal 10A.

At step S11, the server 11 executes the various types of settings, such as the setting on the access right, the setting on the group, and the setting on the classification. The details of the processing of the various types of settings, such as the setting on the access rights, the setting on the groups, and the setting on the classification, at steps S10 and S11 are explained below.

Hereinafter, as an example, a case is explained by referring to FIG. 11, such that, during chatting, the user A shares a file that is stored in the first information processing terminal 10A with the user B.

At step S12, the user A makes an operation to upload a file to the first information processing terminal 10A. For example, at step S12, the user A makes an operation to select a file that is stored in the first information processing terminal 10A, and the user A inputs a command to the first information processing terminal 10A that is for sharing the selected file with the user B.

At step S13, the first information processing terminal 10A transmits, to the server 11, file specifying data for specifying the file that is to be uploaded. For example, at step S13, the first information processing terminal 10A transmits, to the server 11, the file that is stored by the first information processing terminal 10A and that is selected at step S12 by the user A.

At step S14, the server 11 classifies and stores the uploaded file. At step S14, the server 11 classifies the file that is specified by the file specifying data at step S13 based on the setting that is made at step S11, and the server 11 stores the classified file.

At step S15, the server 11 transmits, to the second information processing terminal 10B, the data that indicates that the file is uploaded. Namely, at step S15, the server 11 transmits, to the second information processing terminal 10B, message data that indicates that the file is uploaded. The second information processing terminal 10B displays the received message data to the user B.

The details of the process from step S12 to step S15 are explained below.

<Various Types of Settings>

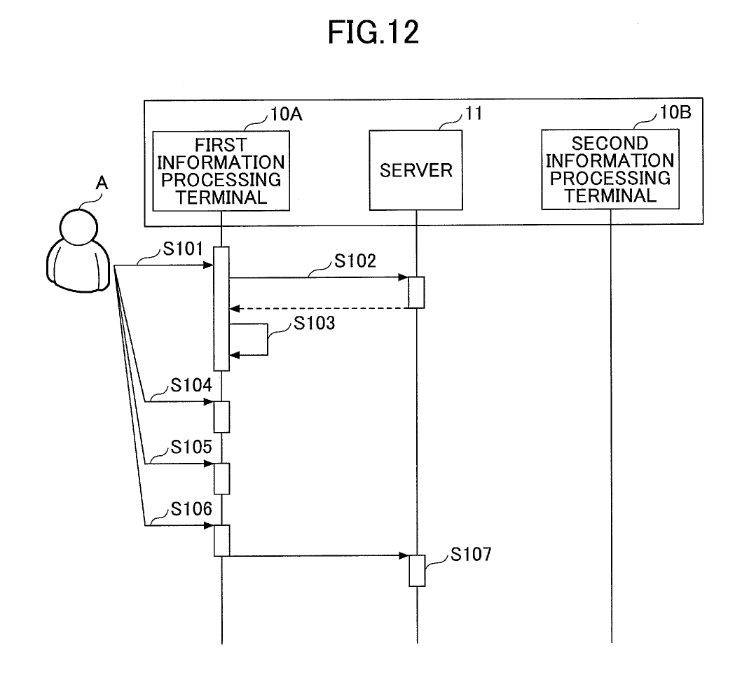

FIG. 12 is a sequence diagram showing an example of various types of settings that are made by the information processing system 1 according to the embodiment of the present invention.

The process that is shown in FIG. 12 corresponds to the details of the process of making the various types of settings at steps S10 and S11, such as the setting on the access rights, the setting on the groups, and the setting on the classification.

In the information processing system 1, various types of settings can be made, such as setting on groups to which a content of chat conversation is to be transmitted, setting on access rights, and setting on classification. For example, in the information processing system 1, the information processing system 1 can make various types of settings, such as the setting on the groups to which the content of the chat conversation is to be transmitted, the setting on the access rights, and the setting on the classification, as described below.

At step S101, the user A makes an operation for instructing the first information processing terminal 10A to start setting.

At step S102, the first information processing terminal 10A requests, from the server 11, various types of data of a user who can participate in the chat and who is registered to the server 11. In response to the request from the first information processing terminal 10A, the server 11 transmits the data of the registered user to the first information processing terminal 10A.

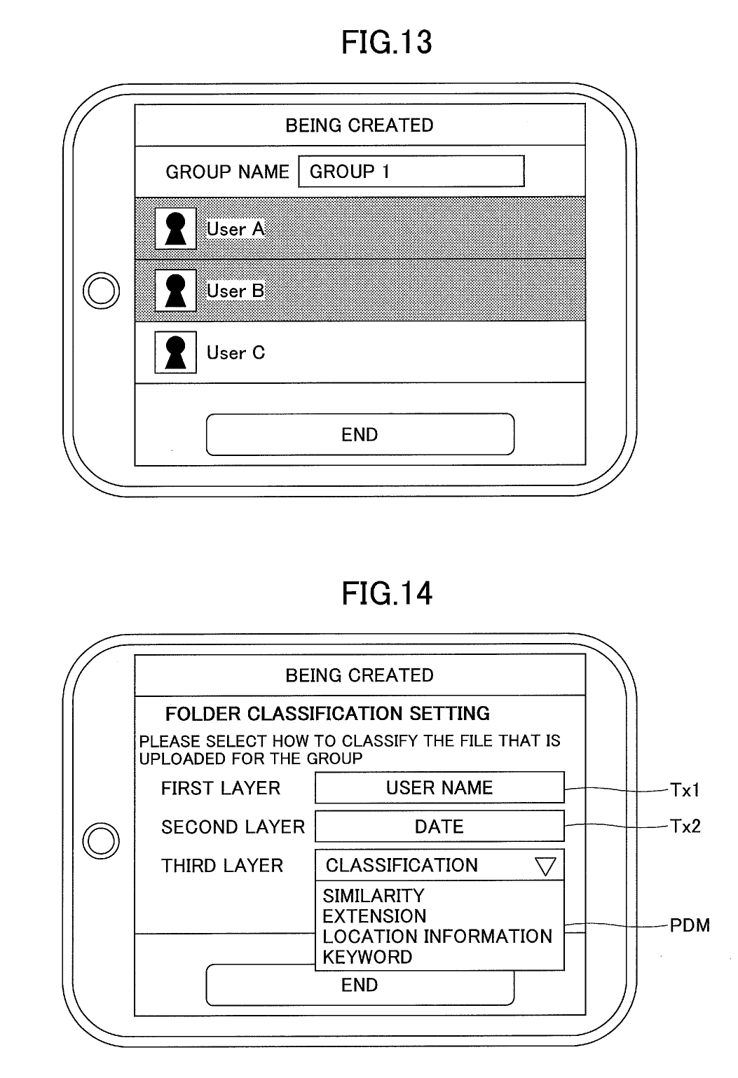

At step S103, the first information processing terminal 10A displays a group creation screen, such as shown in FIG. 13, by using the received data of the registered user.

FIG. 13 is an image diagram showing an example of the group creation screen.

The group creation screen is an example of a screen that is to be displayed in the first information processing terminal 10A for creating a group. The group creation screen that is shown in FIG. 13 may include a field for inputting a group name; and a field for selecting a user, for example. Hereinafter, the process of FIG. 12 is explained by exemplifying a case in which a setting on the group is made by the user A by using the group creation screen that is shown in FIG. 13.

At step S104, the user A makes an operation for setting a group to the first information processing terminal 10A.

At step S104, through the screen that is shown in FIG. 13, the user A operates the first information processing terminal 10A, and the user A inputs a group name into the group creation screen. Further, at step S104, through the screen that is shown in FIG. 13, the user A operates the first information processing terminal 10A, and the user A selects a user who is to be participated in the group in the group creation screen. Additionally, at step S104, the user A sets an access right for each user. For each user who participates in the chat, the setting of the access right can be made by the user A in such a manner that a folder and a file that is stored in a predetermined storage area can be accessed for reading, writing, and executing in the storage area of the server 11.

At step S105, the user A operates the first information processing terminal 10A, and the user A makes a setting on the classification.

FIG. 14 is an image diagram showing an example of a classification setting screen.

The classification setting screen can be a GUI that may include a text box; and a pull-down menu, for example. The classification setting screen may include a user name input text box Tx1; a date input text box Tx2; and a classification pull-down menu PDM.

In the user name input text box Tx1, a user name can be input in the text format.

In the date input text box Tx2, a date for storing various types of files can be input in the text format.

In the classification pull-down menu PDM, parameters for classifying a file are displayed, and a user can make an operation for selecting a parameter from the menu.

Details of the classification are described below.

At step S106, the user A operates the first information processing terminal 10A, and the user A terminates the operation by pressing the end button on the group creation screen. At step S106, the first information processing terminal 10A transmits, to the server 11, the result of the setting that is made at steps S104 and 5105.

At step S107, the server 11 creates a folder for storing the file based on the various types of settings, such as the setting on the group, the setting on the access rights, and the setting on the classification.

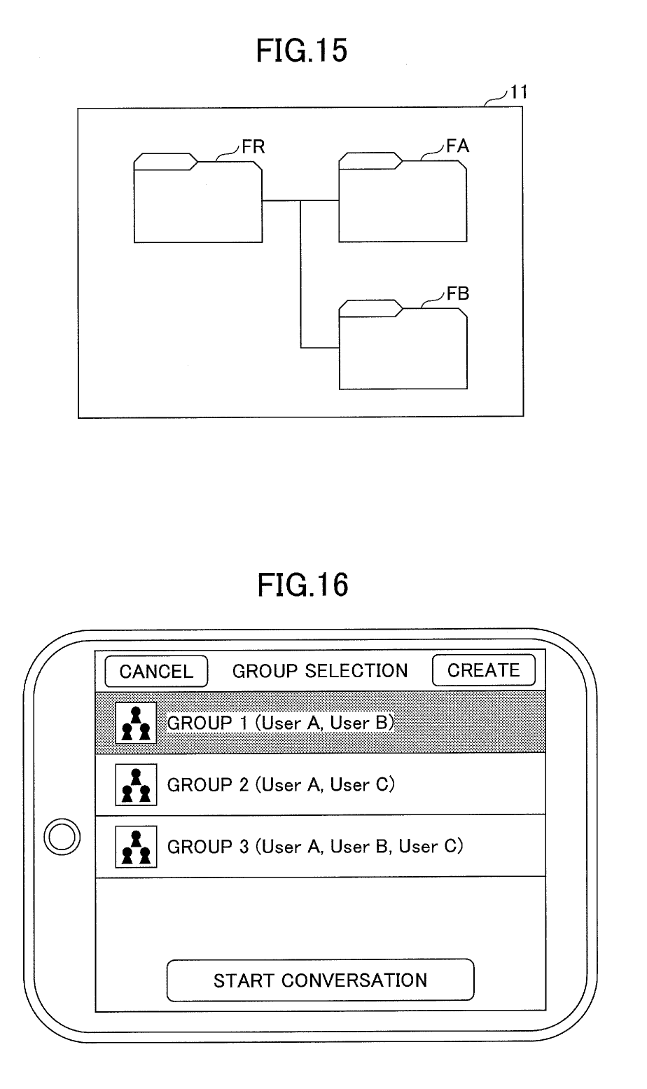

FIG. 15 is a diagram showing an example of a process for creating a folder that is used as a storage unit by the server 11 according to the embodiment of the present invention.

At step S107, the server 11 creates folders, so that the created folders have the structure that is shown in FIG. 15, for example. At step S107, the server 11 creates a root folder FR; a user A folder FA; and a user B folder FB.

The root folder FR is created by the server 11 at the start of chatting, for example. The root folder FR is created at the start of the chatting based on the group that shows participants of the chatting and that is set at step S104. In the group setting that is shown in FIG. 13, a setting is made such that the user A and the user B are the participants. Thus, the server 11 creates the root folder FR by considering that the root folder FR is to be used by the user A and the user B. Specifically, the server 11 creates the root folder FR based on the access rights of the user A and the user B, who are set as the participants in the group setting.

The server 11 searches for a storage destination for which the user A and the user B have the access rights. The server 11 creates the root folder FR at the storage destination which is found. Namely, the root folder FR is created at the storage destination that can be accessed by the user A and the user B.

By creating the root folder FR at the storage destination that can be accessed by the user A and the user B, the user A and the user B can access a folder that is at a lower layer relative to the layer of the root folder FR. The user A and the user B can make an operation to the root folder FR, such as storing a file in the root folder FR, reading out a file that is stored in the root folder FR, and editing a file that is stored in the root folder FR.

Further, the server 11 can make a setting that is for blocking access, by a user other than the participants of the chat, to a folder and a file that are created by chatting, so that the user other than the participants of the chat is prevented from accessing the folder and the the file that are created by chatting.

At step S107, as depicted in FIG. 15, the server 11 creates, for each user who participates in the chat, a folder at a lower layer of the created root folder FR, based on the group setting. The server 11 creates the user A folder FA for the user A, and the server 11 creates the user B folder FB for the user B, for example. For a case in which there is another participant, the server 11 may create a folder for the other participant.

<Chat Process>

As explained below, in the information processing system 1, a chat process can be executed among the information processing terminals that are participated in the group.

FIG. 16 is an image diagram showing an example of a group selection screen for selecting a group for executing a chat process.

A user selects a group for executing a chat process from the group selection screen that is shown in FIG. 16, and the user presses the “start conversation” button, for example. Here, the group information that is to be displayed on the group selection screen can be retrieved from the server 11. The information on the group that is displayed on the group selection screen is the information that corresponds to the group that is selected at step S104, for example. FIG. 16 shows an example in which the user A makes an operation for starting the chat between the user A and the user B on the first information processing terminal 10A.

Upon the “conversation start” button that is shown in FIG. 16 being pressed, the first information processing terminal 10A reports, to the server 11, a group that is selected on the group selection screen and that is for executing a chat process.

The operation that is explained by referring to FIG. 16 is to be executed after the various types of settings that are explained by referring to FIG. 12 are made.

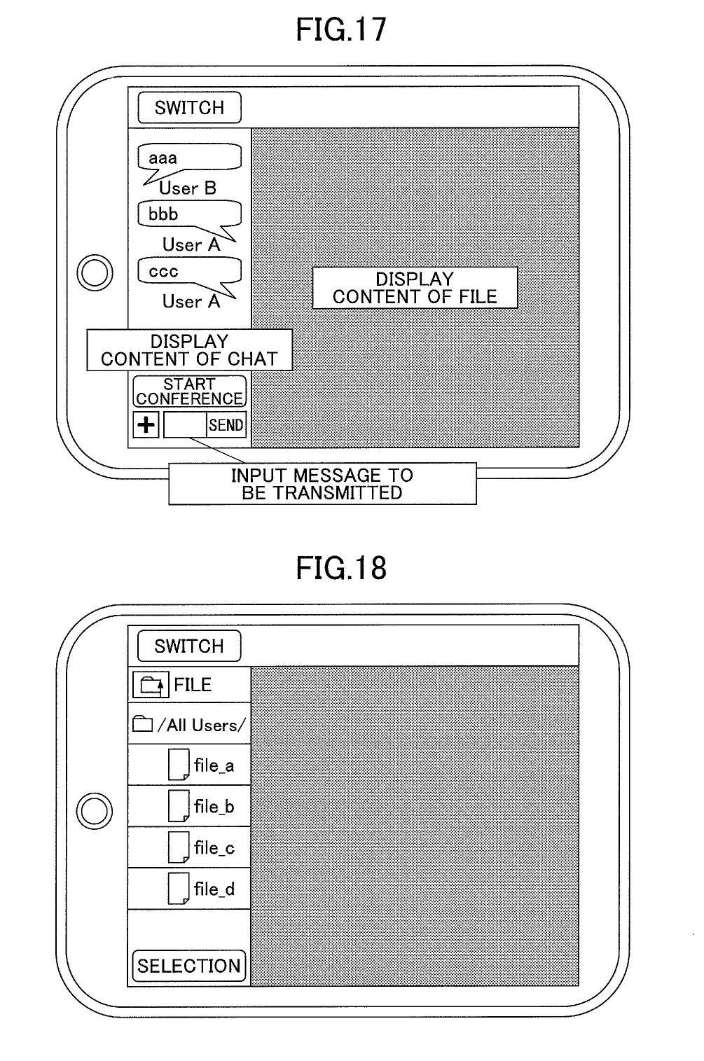

In the information processing terminal that is operated by a user of the group that is for executing the chat process, a chat screen is displayed, such as shown in FIG. 17.

FIG. 17 is an image diagram showing an example of the chat screen.

In the chat screen that is shown in FIG. 17, a content of chat conversation is to be displayed at the left side of the screen, and a box for inputting a message to be transmitted is disposed at a position below the portion where the content of the chat is to be displayed. At the right side of the chat screen that is shown in FIG. 17, a content of a file that is shown in FIG. 18 and that is selected by a user is to be displayed.

Upon the “switch” button that is disposed at an upper portion of the chat screen of FIG. 17 being pressed, the first information processing terminal 10A retrieves a file list from the server 11, and a file selection screen, such as shown in FIG. 18, is displayed.

FIG. 18 is an image diagram showing an example of the file selection screen.

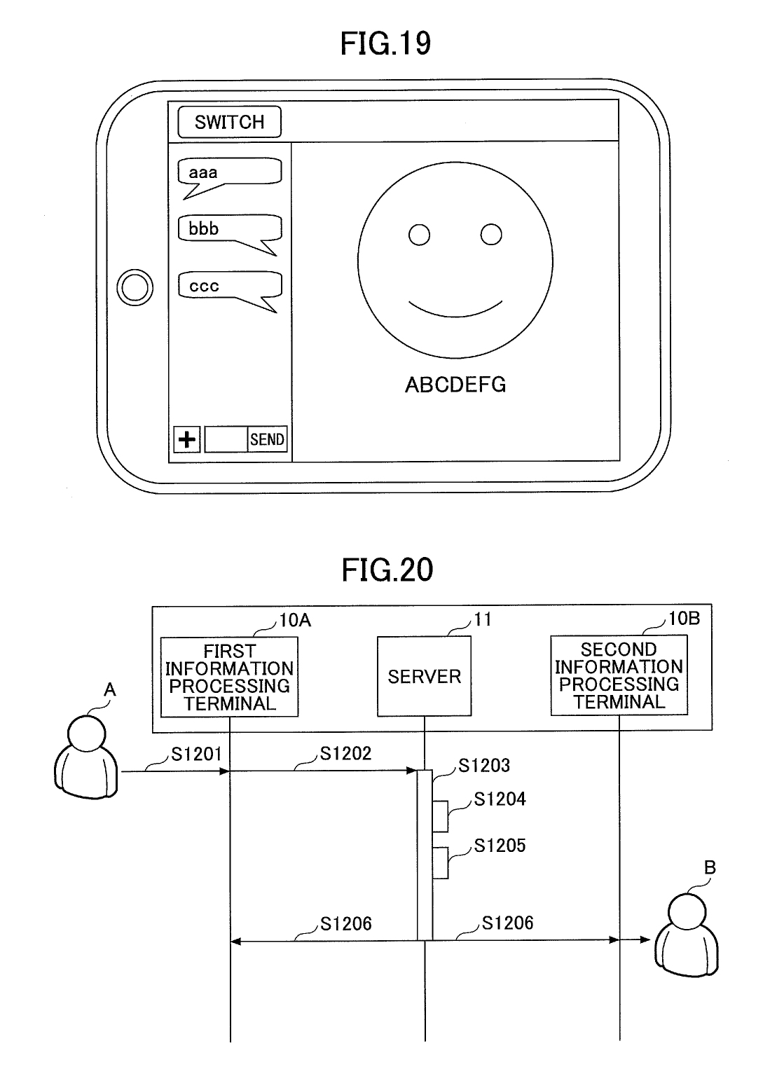

The file selection screen that is shown in FIG. 18 displays a list of files at the left side of the screen. The user A selects a file, a content of which the user desires to display, from the list of the files that is displayed in the file selection screen that is shown in FIG. 18, and the user A presses the selection button. After the user A selects the file from the list of the files, the first information processing terminal 10A retrieves the selected file from the server 11, and the first information processing terminal 10A displays the chat screen, such as shown in FIG. 19.

FIG. 19 is an image diagram showing an example of the chat screen in which the content of the file is displayed.

The chat screen that is shown in FIG. 19 shows an example of the screen such that the content of the file that is selected by the user A from the file selection screen that is shown in FIG. 18 is displayed at the right side of the chat screen that is shown in FIG. 17.

The chat screen that is shown in FIG. 19 may include, for example, a “file sharing” button for sharing a screen that displays a content of a file with the second information processing terminal 10B that is operated by the user B of the group. For example, upon the “file sharing” button of the first information processing terminal 10A being pressed by the user A, the first information processing terminal 10A transmits the file, the content of which is displayed on the screen of the first information processing terminal 10A, to the second information processing terminal 10B, thereby sharing the screen that displays the content of the file between the user A and the user B.

In addition to the “file sharing” button, the first information processing terminal 10A may transmit, to the second information processing terminal 10B that is operated by the user B of the group, a link to the file, the content of which is displayed, as a message.

The process from step S12 to step S15 is to be performed by the participants of the chat during the chat process.

<File Uploading, etc.>

FIG. 20 is a sequence diagram showing an example of a process that is executed by the information processing system 1 according to the embodiment of the present invention during uploading of a file.

The process that is shown in FIG. 20 corresponds to the details of the process from step S12 to step S15.

FIG. 20 shows an example of a case such that, while the user A and the user B are chatting, the user A uploads a file that is to be shared with the user B. In FIG. 20, the process is explained by exemplifying a case in which the file that is to be shared by the user A is stored in the first information processing terminal 10A.

At step S1201, in the first information processing terminal 10A, the user A selects a file that is to be shared with the user B. Hereinafter, the file that is selected by the user A at step S1201 and that is to be shared with another user, such as the user B, is referred to as a shared file. The shared file can be selected by the user A in the file selection screen that is shown in FIG. 18, for example.

At step S1202, the first information processing terminal 10A transmits the shared file to the server 11. At step S1202, the first information processing terminal 10A uploads the shared file to the server 11.

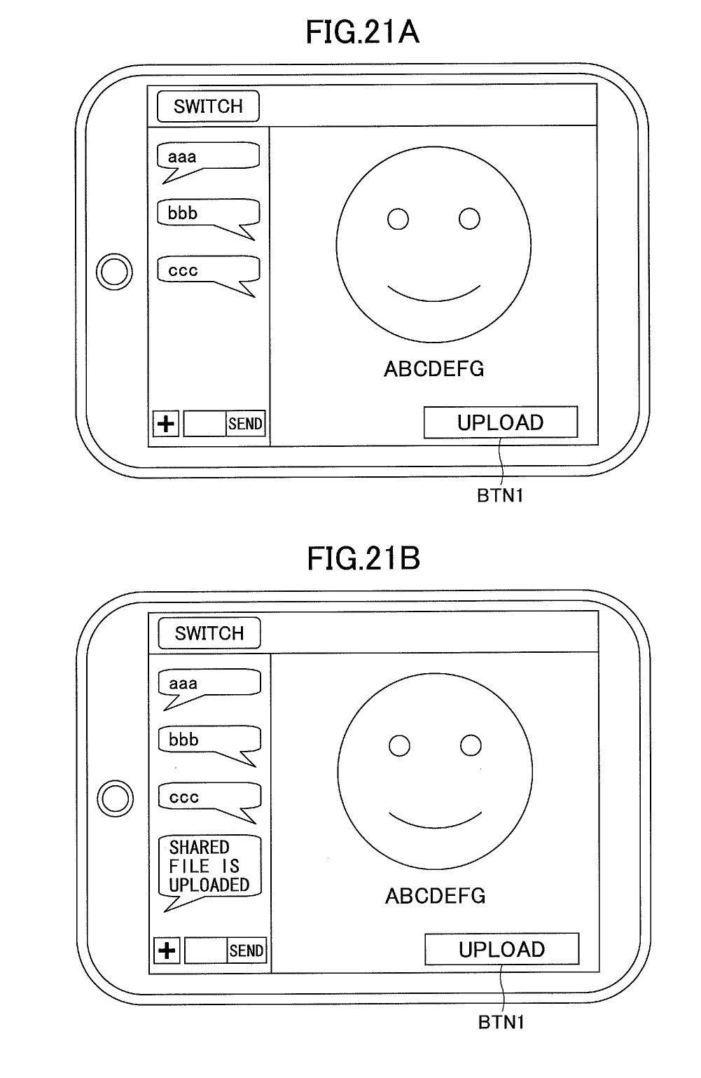

FIGS. 21A and B are diagrams showing an example of an operation screen according to the embodiment of the present invention that is for uploading a file.

FIGS. 21A and B show an example in which the user A uploads the file in the chat screen that is shown in FIG. 19.

FIG. 21A is a diagram showing the example of the operation screen according to the embodiment of the present invention that is for uploading the file.

By providing a GUI that is an “UPLOAD” button BTN1 in the display showing the content of the file, such as shown in FIG. 19, the first information processing terminal 10A can prompt the user A to upload the file. The operation of pressing the “UPLOAD” button BTN1 by the user A in the screen that is shown in FIG. 21A corresponds to the operation at step S1201. In the screen that is shown in FIG. 21A, upon the “UPLOAD” button BTN1 being pressed by the user A, the first information processing terminal 10A transmits the file that is displayed in FIG. 21A to the server 11.

FIG. 21B is a diagram showing an example of the operation screen that indicates that the operation of uploading the file according to the embodiment of the present invention is completed.

After uploading the shared file to the server 11 at step S1202, the first information processing terminal 10A can display a message that indicates that the uploading of the file is completed, as shown in the operation screen of FIG. 21B, for example.

At step S1203, the server 11 classifies the file based on classification data that represents classification of files, and the server 11 stores the classified file.

Specifically, step S1203 includes step S1204 and step S1205. In step S1203, the server 11 searches for a storage destination at step S1204, and at step S1205, the server 11 classifies the shared file that is transmitted at step S1202 and stores the classified shared file in the detected storage destination.

At step S1204, the server 11 searches for the storage destination based on the classification data that represents the classification of the files that is set in the classification setting screen that is shown in FIG. 14.

At step S1205, the server 11 classifies the shared file that is transmitted at step S1202 based on the classification data, and the server 11 stores the classified shared file in the storage destination that is detected at step S1204.

At step S1206, the server 11 transmits message data that includes file storage data that represents the stored file to the first information processing terminal 10A and to the second information processing terminal 10B. The file storage data can be, for example, a file path that represents the storage destination that is stored at step S1205, for example.

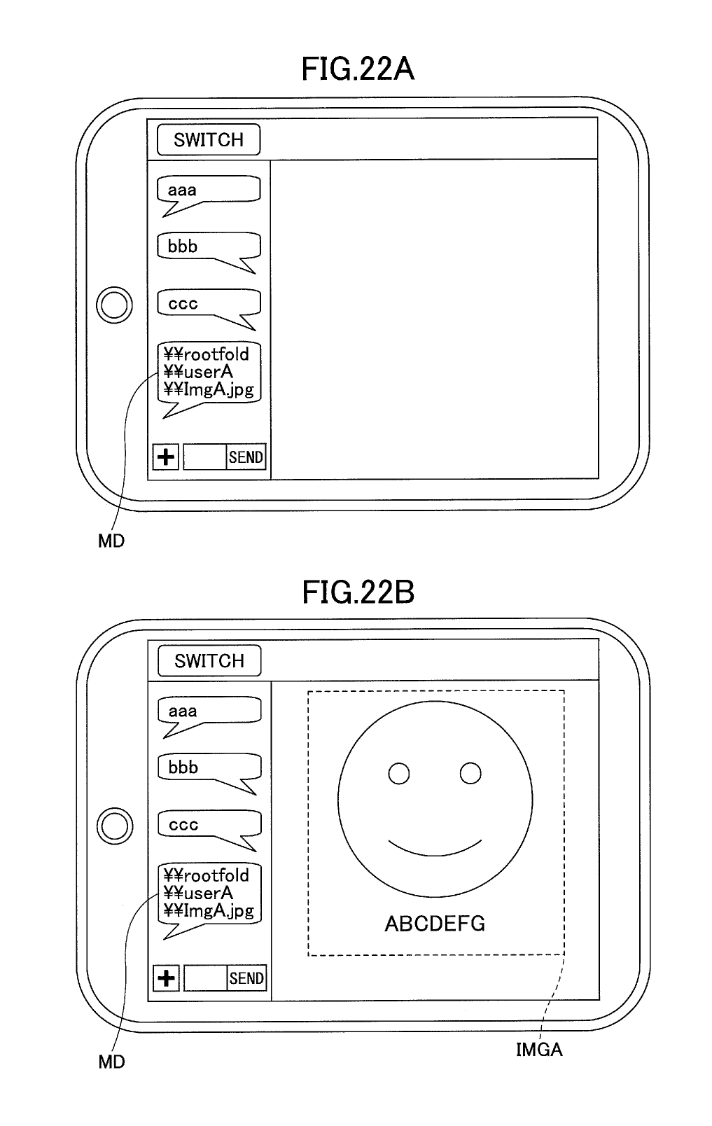

FIGS. 22A and 22B are diagrams showing an example of the message data that includes the file storage data according to the embodiment of the present invention.

FIG. 22A is a diagram showing an example of the chat screen of the second information processing terminal 10B according to the embodiment of the present invention.

Upon the server 11 transmitting the message data including the file storage data to the second information processing terminal 10B at step S1206, the second information processing terminal 10B displays message data MD. The message data MD can be data that represents the file path or the like that indicates the storage destination of the shared file that is stored at step S1205. A so-called “link” can be set to the message data MD, for example. For a case in which the link is set to the message data, by clicking the portion where the message data MD is displayed, the user B can access the shared file that is uploaded by the user A.

Note that the message data MD is not limited to the data that represents the file path. The message data MD may be a file name, for example. FIG. 22B is a diagram showing an example of displaying the shared file in the chat screen by the second information processing terminal 10B according to the embodiment of the present invention.

FIG. 22B shows an example of the chat screen that is displayed after the user B clicks the portion where the message data MD is displayed in FIG. 22A. Upon the portion where the message data MD is displayed being clicked by the user B, the second information processing terminal 10B retrieves the file that is indicated in the file storage data from the server 11, and the second information processing terminal 10B displays the content of the retrieved file, similar to the case of FIG. 19. Namely, upon the portion where the message data MD is displayed being clicked by the user B, the second information processing terminal 10B displays the content of the shared file.

Note that the shared file that is selected at step S1201 is not limited to the file that is stored in the first information processing terminal 10A. The shared file may be a file that is stored in the server 11, for example. For sharing the file that is stored in the server 11, the user A can select the file that is stored in the server 11 at step S1201. For a case in which the shared file is a file that is stored in the server 11, the file specifying data may be data that indicates the storage destination that stores the file.

<Entire Process by the Devices>

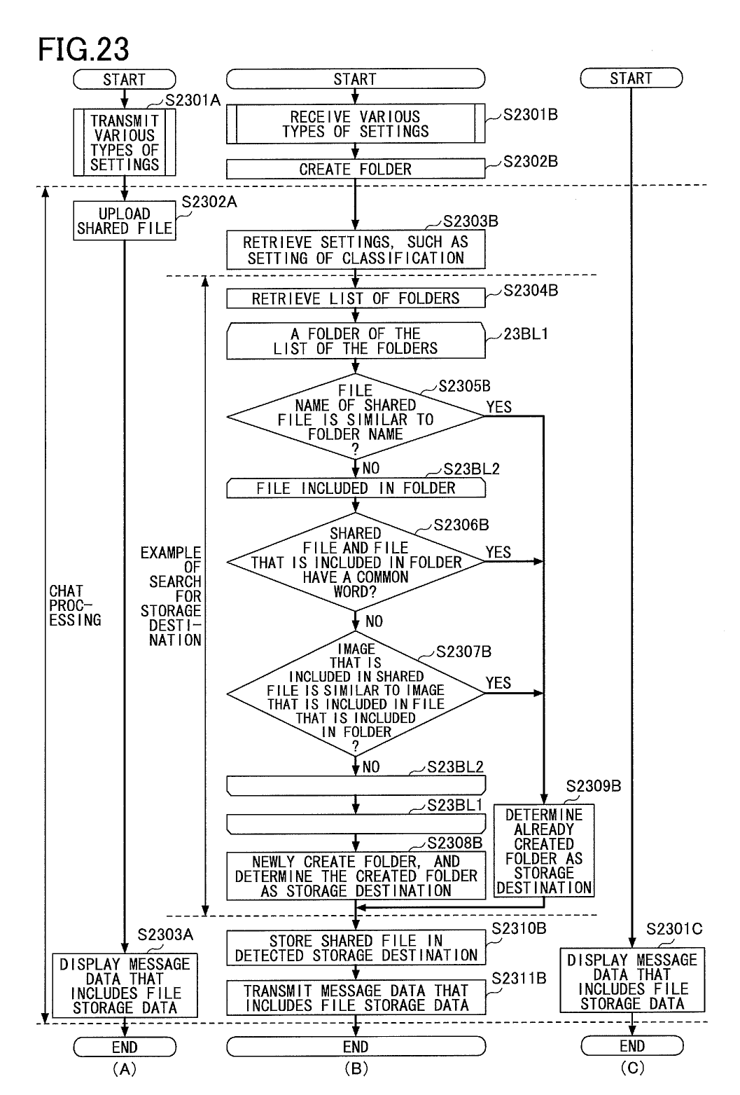

FIG. 23 is a flowchart showing an example of the entire processes by the devices according to the embodiment of the present invention.

In FIG. 23, (A) is the flowchart of the entire process by the first information processing device 10A according to the embodiment of the present invention.

At step S2301A, the first information processing terminal 10A transmits various types of settings. The process at step S2301A corresponds to the transmission process that is executed by the first information processing terminal 10A at step S106.

At step S2302A, the first information processing terminal 10A uploads the shared file. The process at step S2302A corresponds to the process at step S1201.

At step S2303A, the first information processing terminal 10A displays message data that includes the file storage data. The process at step S2303A corresponds to the case in which, for the process at step S1206, a process that is the same as the process that is explained by referring to FIGS. 22A and 22B is executed by the first information processing terminal 10A.

In FIG. 23, (B) is a flowchart showing an example of the entire process by the server 11 according to the embodiment of the present invention.

At step S2301B, the server 11 receives various types of settings. At step S23013, the server 11 receives the various types of settings that are transmitted by the first information processing terminal 10A at step S2301A.

At step S2302B, the server 11 creates a folder. The process at step S2302 can be the process that is explained by referring to FIG. 15, for example.

At step S2303B, the server retrieves settings, such as the setting of the classification. The process at step S2303B is the process of retrieving the settings with respect to the shared file that are transmitted by the first information processing terminal 10A at step S2302A, among the various types of settings that are received at step S2301B.

The process from step S2034B to step S2309B is an example of the process at step S1204. The process from step S2304B to step S2309B is an example of a case in which, in the classification setting screen that is shown in FIG. 14, the condition of “SIMILARITY” is selected. Hereinafter, the process is explained by exemplifying the case in which the condition of “SIMILARITY” is selected as the condition for classifying the files.

At step S2304B, the server 11 retrieves a list of folders. In response to detecting that a plurality of folders is created, for example, by the process at step S2302B, the server 11 retrieves the list of the folders that is the data for identifying the folders that are stored in the server 11.

Based on the list of the folders that is retrieved at step S2304B, for each of the folders that are identified by the list of the folders, the process from step S2305B to step S2307B is executed by the loop S23BL1.

At step S2305B, the server 11 determines, for example, whether a file name of the shared file is similar to a folder name. Upon determining, by the server 11, that the file name of the shared file is similar to the folder name at step S2305B (YES at step S2305B), the server 11 proceeds to step S2309B. Upon determining, by the server 11, that the file name of the shared file is not similar to the folder name at step S2305B (NO at step S2305B), the server 11 proceeds to step S2306B.

The process of determining whether the file name of the shared file is similar to the folder name is a process that is to be executed by the server 11, for example, if the file name of the shared file and the folder name of the folder that is to be the storage destination include the same user names. The server 11 can create a folder having a folder name that includes a user name, for example, in the process at step S2303B because the user name can be input into the user name input text box Tx1 in the operation screen that is shown in FIG. 14. Suppose that the shared file is created with the file name that includes a user name. For a case in which the server 11 is to store the shared file in the folder having a folder name that includes the user name that is the same as the user name of the shared file, the server 11 determines whether the file name of the shared file is similar to the folder name, based on whether the folder name includes the user name that is the same as the user name that is included in the file name of the shared file.

The process of determining whether the file name of the shared file is similar to the folder name is a process that is to be executed by the server 11, for example, if the date that is included in the file name of the shared file is the same as the date that is included in the folder name of the folder that is to be the storage destination. The server 11 can create a folder having a folder name that includes a date, for example, in the process at step S2303B because the date can be input into the date input text box Tx2 in the operation screen that is shown in FIG. 14. Suppose that the shared file is created with the file name that includes a number that represents a date, for example. For a case in which the server 11 is to store the shared file in the folder having a folder name that includes a date that is the same as the date of the shared file, the server 11 determines whether the file name of the shared file is similar to the folder name based on whether the folder name includes the date that is the same as the date that is included in the file name of the shared file.

Namely, at step S2305B, if the folder name and the file name are created by a common naming rule, for example, based on the user name or the date, the server 11 searches for, as a storage destination, a folder having a folder name that includes text that is the same as the text that is included in the file name.

By the loop S23BL2, for each of files that are included in the identified folder, the process from step S2306B to step S2307B is executed.

At step S2306, the server 11 determines whether the shared file and a file that is included in the folder have a common word (i.e., the shared file and the file that is included in the folder include the same words). In response to determining, by the server 11, that the shared file and the file that is included in the folder have a common word at step S2306B (YES at step S2306B), the server 11 proceeds to step S2309B. In response to determining, by the server 11, that the shared file and the file that is included in the folder do not have any common word at step S2306B (NO at step S2306B), the server 11 proceeds to step S2307B.

The process of determining whether the shared file and the file that is included in the folder have a common word is a process that is to be executed by the server 11, for example, if the shared file and the file that is included in the folder are files that include text, such as text data or document data. In the process, first, the server 11 parses words that are included in the shared file and the file that is included in the folder. Then, the server 11 extracts, for each of the shared file and the file that is included in the folder, words that are included in the corresponding file more than predetermined times. Among the extracted words, if the word that appears most frequently in the shared file matches the word that appears most frequently in the file that is included in the folder, the server 11 determines that the shared file and the file that is included in the folder have a common word (YES at step S2306B).

At step S2306B, the fact can be utilized such that, if a word that appears most frequently in a file is the same as a word that appears most frequently in another file, it is highly likely that these files are used for the same conversation or the same conference.

Namely, at step S2306B, in order to collect, in the same storage destination, files that include similar contents, the server 11 searches for, as the storage destination, a folder that stores a file that has a common word with the shared file.

Here, the process at step S2306B may be a process such that, if each of the folders includes a plurality of files, the server 11 searches for a folder that stores the largest number of similar files.

At step S2307B, the server 11 determines whether an image that is included in the shared file is similar to an image that is included in a file that is included in the folder. Upon determining, by the server 11, that the image that is included in the shared file is similar to the image that is included in the file that is included in the folder at step S2307B (YES at step S2307B), the server 11 proceeds to step S2309B. Upon determining, by the server 11, that the image that is included in the shared file is not similar to the image that is included in the file that is included in the folder at step S2307B (NO at step S2307B), the server 11 proceeds to step S2308B.

The process of determining whether the image that is included in the shared file is similar to the image that is included in the file that is included in the folder is a process that is to be executed by the server 11, for example, if the shared file and the file that is included in the folder are files that include images, such as image data or document data including image data. In the process, the server 11 applies an image recognition process to each of the image that is included in the shared file and the image that is included in the file that is included in the folder, for example. If a determination is made that the same objects are depicted in the image that is included in the shared file and the image that is included in the file that is included in the folder, the server 11 may determine that the images are similar to each other. The process may be implemented by a process, such as the pattern matching process.

At step S2307B, the fact can be utilized such that, if an object that is depicted in the image that is included in the shared file is the same as an object that is depicted in the image that is included in the file that is included in the folder, it is highly likely that these files are used for the same conversation or the same conference.

Namely, at step S2307B, in order to collect, in the same storage destination, files that include similar images, the server 11 searches for, as the storage destination, a folder that stores a file that includes an image that is similar to an image that is included in the shared file.

Here, the process at step S2307B may be a process such that, if each of the folders includes a plurality of files, the server 11 searches for a folder that stores the largest number of files that are determined to be similar.

At step S2308B, the server newly creates a folder, and the server 11 determines the created folder as a storage destination.

At step S2309B, the server 11 determines a folder that is already created as the storage destination. For example, for the case of YES at step S2305B, the server 11 determines the already created folder having the folder name that is similar to the file name of the shared file as the storage destination.

At step S2310B, the server 11 stores the shared file in the detected storage destination. At step S2310B, the server 11 stores the shared file in the storage destination that is determined at step S2308B or at step S2309B.

At step S2311B, the server 11 transmits message data that includes file storage data. The process at step S2311B corresponds to the process at step S1206. The file storage data can be data, such as a path, that indicates the storage destination that is determined at step S2308B or at step S2309B.

Note that the search for the storage destination is not limited to the case of implementing by the process from step S2305 to step S2307. The search for the storage destination may be implemented by one process that is included in the process from step S2305 to step S2307, for example. Additionally, the search for the storage destination may be implemented by combining it with a process for determining another type of similarity.

In FIG. 23, (C) is a flowchart showing an example of the entire process of the second information processing terminal 10B according to the embodiment of the present invention.

At step S2301C, the second information processing terminal 10B displays the message data that includes the file storage data. The process at step S2301C corresponds to the process that is explained by referring to FIG. 22.

<Effect>

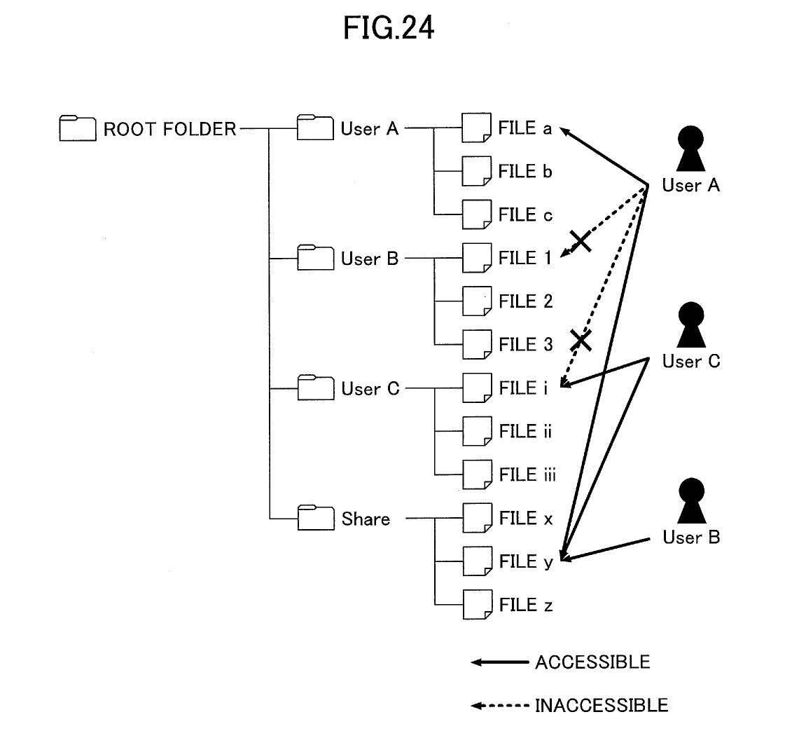

FIG. 24 is a diagram showing an example of a method of sharing a file according to related art.

Hereinafter, the method of sharing a file according to the related art is explained by exemplifying a case in which participants of chatting and users of the information processing system according to the related art that stores the files that are shown in FIG. 24 are a user A, a user B, and a user C.

Suppose that, in the information processing system according to the related art that is shown in FIG. 24, the user A has the right for accessing a “User A” folder and a “Share” folder. Similarly, suppose that the user B has the right for accessing a “User B” folder and the “Share” folder. Similarly, suppose that the user C has the right for accessing a “User C” folder and the “Share” folder.

The method is explained by exemplifying a case such that, during chatting among the user A, the user B, and the user C, the user A desires to share a “file a” with the user B and the user C.

The “file a” is stored in the “User A” folder. Among the user A, the user B, and the user C, only the user A has the right for accessing the “User A” folder. Thus, in order to share the “file a,” the user A may copy the “file a,” or the user A may move the “file a.”

Thus, for sharing the “file a,” workload may occur for the user A to search for the “Share” folder that is a storage destination. Here, the user A, the user B, and the user C have the rights for accessing the “Share” folder, respectively. Furthermore, for a case in which the user A copies or moves the “file a” to the “Share” folder, workload may occur for the user A to inform the user B and the user C by e-mail, for example.

Furthermore, for a case in which the user A may not find the “Share” folder immediately, the user A, the user B, and the user C may not share the “file a” immediately.

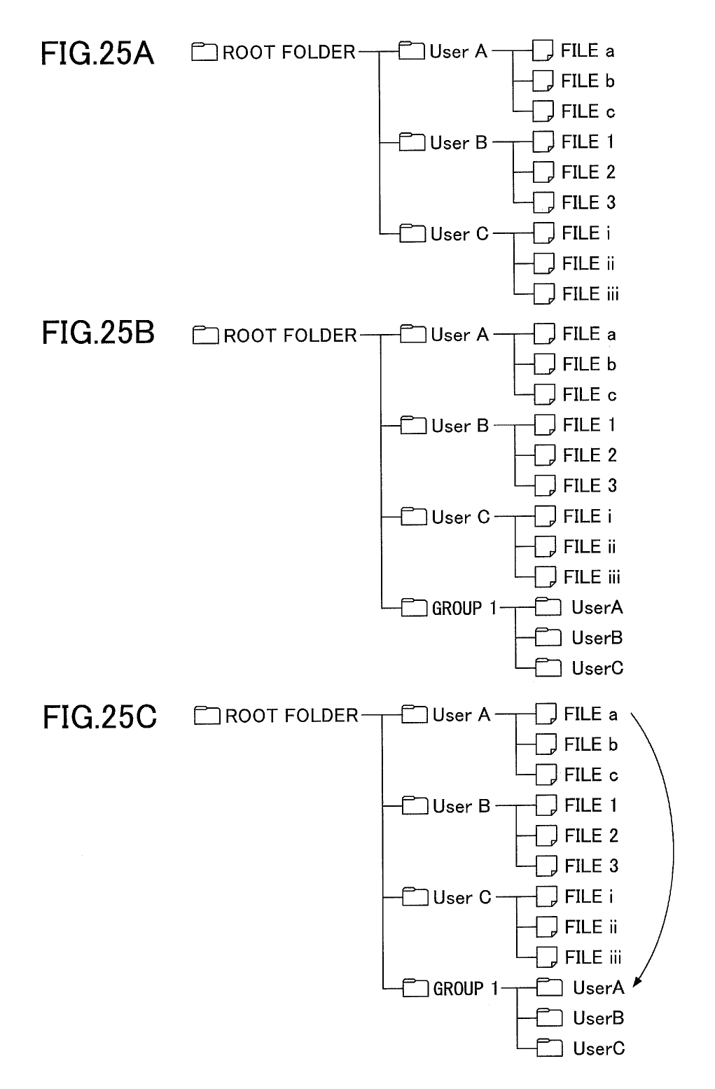

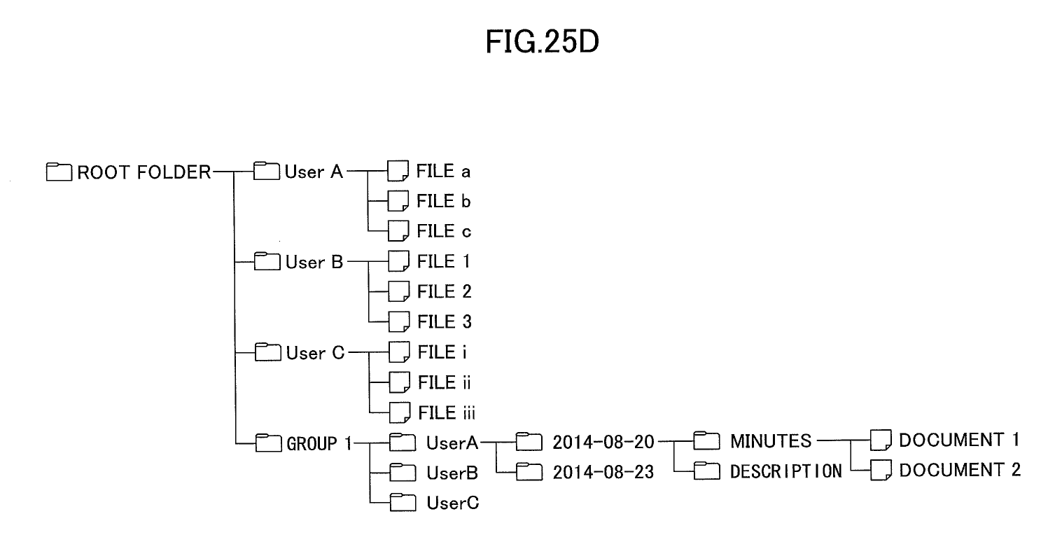

FIGS. 25A-25D are diagrams showing an example of an effect of the process by the information processing system 1 according to the embodiment of the present invention.

Hereinafter, the effect is explained by exemplifying a case in which participants of chatting and users of the information processing system 1 according to the embodiment of the present invention that stores the files that are shown in FIG. 25 are a user A, a user B, and a user C.

FIG. 25A is a diagram showing an example of files that are stored in the information processing system 1 according to the embodiment of the present invention and a folder structure.

In the information processing system 1 according to the embodiment of the present invention, suppose that the user A has the right for accessing a “User A” folder. Similarly, suppose that the user B has the right for accessing a “User B” folder. Similarly, suppose that the user C has the right for accessing a “User C” folder.

FIG. 25A is a diagram showing an example of a state prior to making various types of settings, namely, the state prior to executing the entire process by the information processing system 1 that is shown in FIG.11.

FIG. 25B is a diagram showing an example of a result of the process based on the various types of settings by the information processing system 1 according to the embodiment of the present invention.

The state that is shown in FIG. 25B corresponds to the state after the process of step S2302B is executed. The server 11 creates a “group 1” folder as a storage destination for which the user A, the user B, and the user C have the access rights, respectively. For the “group 1” folder, among the various types of settings, a folder name is determined, for example, based on the “group name” that is input to the operation screen that is shown in FIG. 13.

The server 11 creates the “User A” folder, the “User B” folder, and the “User C” folder that correspond the participants of chatting at a lower layer of the group 1 folder. The user A has the access right for accessing the “User A” folder, the “User B” folder, and the “User C” folder. The user B has the access right for accessing the “User A” folder, the “User B” folder, and the “User C” folder. The user C has the access right for accessing the “User A” folder, the “User B” folder, and the “User C” folder. Furthermore, the “group 1” folder, the “User A” folder, the “User B” folder, and the “User C” folder are folders such that a user other than the participants of chatting may not have the access right for accessing these folders.

An exemplary case is explained such that, during chatting, the user A uploads a “file a” as a shred file. In the process of searching for a storage destination, the server 11 determines the “User A” folder of the “group 1” folder as the storage destination because the “file a” is a file that is owned by the user A of the “group 1.” The server 11 stores the “file a” that is the shared file in the “User A” folder that is the storage destination that is detected by the process of searching.

FIG. 25C is a diagram showing an example of a result of the process of uploading the “file a” by the information processing system 1 according to the embodiment of the present invention.

The “file a” that is the shared file can be shared with the user B and the user C because the “file a” that is the shared file is stored in the “User A” folder of the “group 1” folder. Note that the user B and the user C have the access rights for accessing the “User A” folder. Additionally, the security of storing the “file a” can be enhanced because a user other than the user A, the user B, and the user C may not have the access right for accessing the “User A” folder of the “group 1” folder. Consequently, the workload on the user A can be reduced that is for sharing the file with the user B and the user C, namely, the workload for searching for the storage destination and for informing the storage destination can be reduced.

Note that the server 11 may use other settings.

FIG. 25D is a diagram showing an example of the effect of the classification setting by the information processing system 1 according to the embodiment of the present invention based on a date, a user, an extension, and a keyword.

The classification setting is based on the data that is input into the classification setting screen that is shown in FIG. 14.

The server 11 creates, for example, for each of items of date data that are input into the date field of the classification setting screen that is shown in FIG. 14, a folder at a lower layer of the “User A” folder of the “group 1” folder. For the case of FIG. 25D, the server 11 creates a “2014-08-20” folder and a “2014-08-23” folder. For example, for a case in which the date data is input into the file name of the shared file, the server 11 determines a folder having the same date as a storage destination of the shared file. For example, in the folder structure that is shown in FIG. 25D, a file that is created on Aug. 20, 2014 can be stored in the “2014-08-20” folder, as a storage destination, in the process at step S2305B.

The server 11 can collect and store files having the same date by classifying and storing the files based on the date data.

The server 11 stores a file that is uploaded by the user A in the “User A” folder of the “group 1” folder. For example, when the folder structure is as shown in FIG. 25D and user data is stored that describes that the creator of the “Document 1” file and the “Document 2” file is the user A, the server 11 determines the “User A” folder of the “group 1” folder as the storage destination, based on the user data.

Instead of the user data, the server 11 may use location data that indicates a location of each user. When the information processing terminal that is used by a user includes a Global Positioning System (GPS) receiver or the like, the location data of the user can be obtained from the information processing terminal. For example, the server 11 may store, in the same folder, files including location data that indicates the same location. It is highly likely'that users whose location data indicates the same location are participating in the same conference. Consequently, by classifying and storing files based on location data, the server 11 can collect and store the files that are related to the same conference.

By classifying and storing files based on user data, the server 11 can collect and store the files that are related to the same user.

The server 11 classifies the files that are uploaded by each user based on extensions of the files, and the server 11 stores the classified files at a lower layer of the “group 1” folder. For example, the “Document 1” file and the “Document 2” file that are depicted in FIG. 25D are document files of the same type. Thus, each of the “Document 1” file and the “Document 2” file includes extension data that indicates that it is a document file. The server 11 stores, in the same folder, the “Document 1” file and the “Document 2” file that include the same extension data that indicates that the file is the document file.

By classifying and storing files based on extension data, the server 11 can collect and store the files that are of the same type.

The server 11 can store, for each of the same or similar keywords, the uploaded files in the “group 1” folder. For example, in the folder structure that is shown in FIG. 25D, the server 11 creates a “minutes” folder and a “description” folder. For example, suppose that the “Document 1” file and the “Document 2” file are files that are created in the same conference. The server 11 stores a keyword that indicates the conference in which the “Document 1” file and the “Document 2” file are created and/or a keyword that indicates the content of the conference in which the “Document 1” file and the “Document 2” file are created. If a word that is included in the “Document 1” file is the same as or similar to the word that is represented by the keyword data, and if a word that is included in the “Document 2” file is the same as or similar to the word that is represented by the keyword data, the server 11 stores the “Document 1” file and the “Document 2” file in the “minutes” folder. The server 11 may calculate, for each file, a degree of similarity as a similarity-degree. For example, the server 11 may store, for each keyword, the files that have similarity-degrees that are greater than or equal to a predetermined value in the same storage destination.

By classifying and storing files based on a keyword, the server 11 can collect and store the files that are related to the same or similar keyword.

Each user can specify, by using the information processing terminal or the like, a file that is desired to be shared by the file specifying data. The server 11 searches for a storage destination that can be accessed by all the participants of the chat, based on access right data that represents access rights that are set for respective users who participate in the chat. The server 11 can classify files that have similar contents based on a date, a user, an extension, a keyword, and the like, and the server 11 can store the classified files in the same folder. The server 11 can store the shared file that is specified by the file specifying data. The server 11 can enclose file storage data, such as a file path that indicates a location where the shared file is stored, in message data, and the server 11 can transmit the message data including the file storage data to the users.

Each user can find the destination where the shared file is stored based on the transmitted message data. Consequently, each user can access the shared file that is stored in the notified storage destination. In this manner, for the user who uploads the shared file, for example, workload can be reduced that is for searching for a storage destination and that is for informing the storage destination to the other users.

### Another Embodiment

<System Configuration>

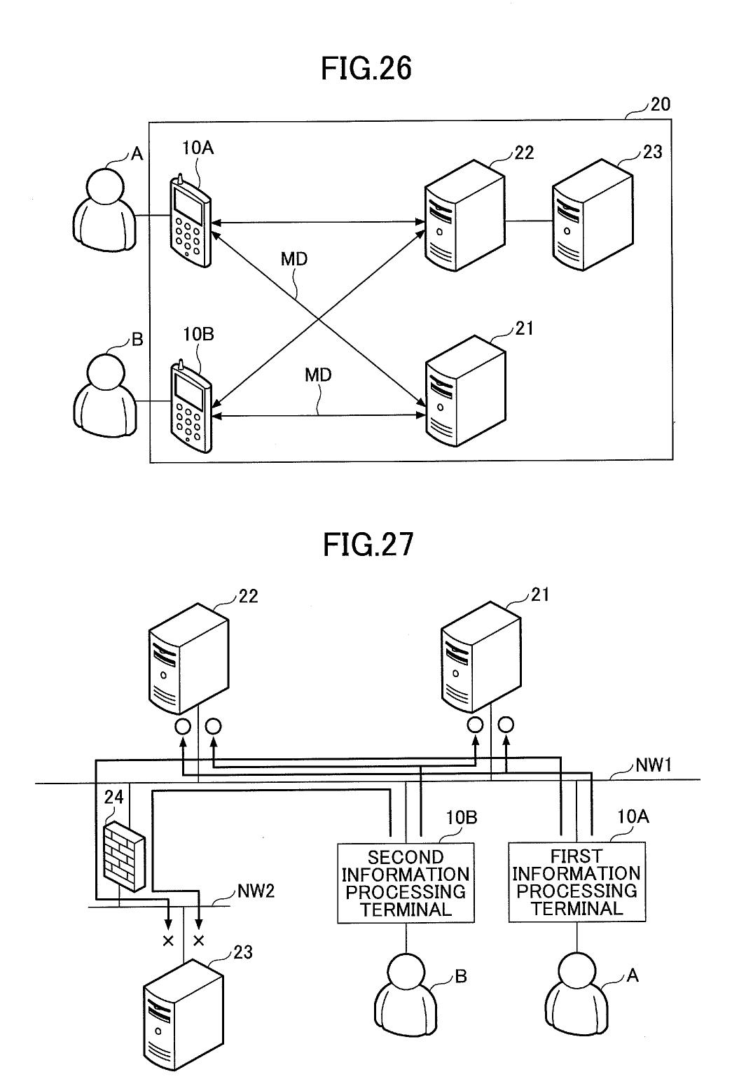

FIG. 26 is a diagram showing an example of an overall configuration of an information processing system according to another embodiment of the present invention.

In this embodiment, a system configuration of the information processing system 20 that is shown in FIG. 26 is used, instead of the system configuration according to the embodiment that is shown in FIG. 1.

The information processing system 20 may include the first information processing terminal 10A; the second information processing terminal 10B; a chat server 21; a relay server 22; and a file storage 23.

The first information processing terminal 10A according to this embodiment may have the same hardware configuration and functions as those of the above-described first information processing terminal 10A. Similarly, the second information processing terminal 10B according to this embodiment may have the same hardware configuration and functions as those of the above-described second information processing terminal 10B. Thus, their explanations are omitted.

The chat server 21, the relay server 22, and the file storage 23 may have the same hardware configuration as that of the above-described server 11.

FIG. 27 is a block diagram showing an example of an effect of the information processing system according to this embodiment of the present invention.

A relay device may be the relay server 22, for example. Hereinafter, the embodiment is explained by exemplifying a case in which the relay device is the relay server 22.

In this embodiment, an information processing device may be the chat server 21 and the file storage 23. Hereinafter, the embodiment is explained by exemplifying a case in which the information processing device is the chat server 21 and the file storage 23.

The file storage 23 can be connected to a local network NW2, such as an office local area network (LAN). The file storage 23 can store various types of files.

The first information processing terminal 10A and the second information processing terminal 10B can access the chat server 21 and the relay server 22 via the internet NW1. In contrast, the first information processing terminal 10A and the second information processing terminal 10B may not access, via the internet NW1, the file storage 23 that is connected to the local area network NW2.

Access from the first information processing terminal 10A and the second information processing terminal 10B via the internet NW1 may be blocked by a firewall 24.

Thus, the first information processing terminal 10A and the second information processing terminal 10B may not directly access and use the file that is stored in the file storage 23 that is connected to the local network NW2.

When the first information processing terminal 10A is to use a file that is stored in the file storage 23, the first information processing terminal 10A can transmit a request to the relay server 22. Similarly, when the second information processing terminal 10B is to use a file that is stored in the file storage 23, the second information processing terminal 10B can transmit a request to the relay server 22. The relay server 22 can execute a process for requesting a file or the like from the file storage 23, based on the received request. The file storage 23 can transmit, for example, a requested file to the relay server 22 based on the request from the relay server 22.

By using the relay server 22, the first information processing terminal 10A and the second information processing terminal 10B can use a file that is stored in the file storage 23, even if the first information processing terminal 10A and the second information processing terminal 10B are prevented from accessing, via the internet NW1, the file storage 23. Additionally, the security of the file that is stored in the file storage 23 can be enhanced by the firewall 24 because access from outside to the file storage 23 can be blocked.

<Functional Configurations of the Devices>

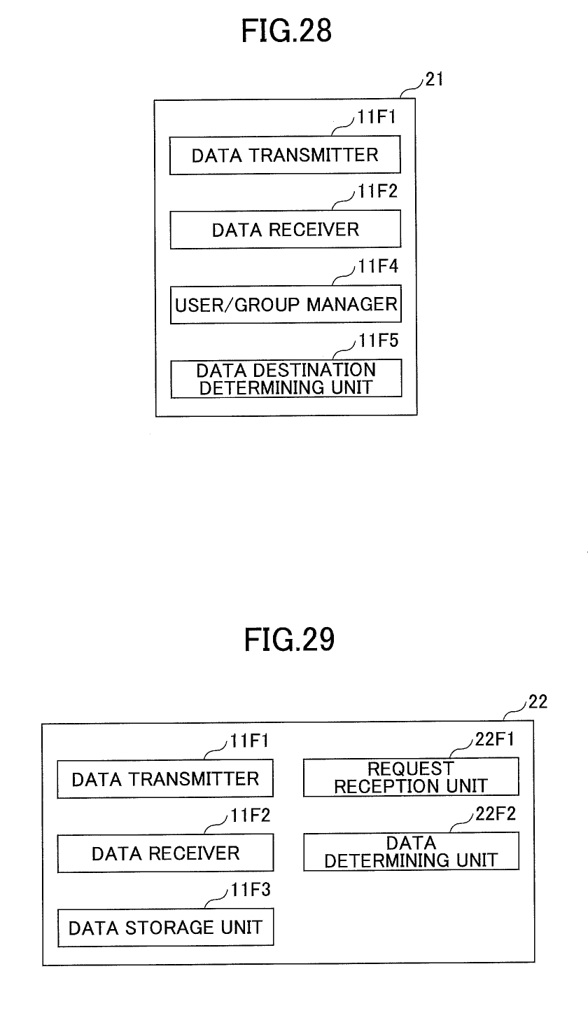

FIG. 28 is a functional block diagram showing an example of a functional configuration of the chat server 21 according to this embodiment of the present invention.

The chat server 21 can be implemented by the functional configuration, such as that of depicted in FIG. 28.

The chat server 21 may include a data transmitter 11F1; a data receiver 11F2; a user/group manager 11F4; and a data destination determining unit 11F5.

Functions of the data transmitter 11F1, the data receiver 11F2, the user/group manager 11F4, and the data destination determining unit 11F5 are the same as those of the units that are explained by referring to FIG. 5. In the following, the same reference numeral may be attached to the same functions, and thereby the explanation is omitted.

FIG. 29 is a functional block diagram showing an example of a functional configuration of the relay server 22 according to the embodiment of the present invention.

The relay server 22 can be implemented by a functional configuration, such as that of shown in FIG. 29.

The relay server 22 may include a data transmitter 11F1; a data receiver 11F2; a data storage unit 11F3; a request reception unit 22F1; and a data determining unit 22F2.

Functions of the data transmitter 11F1, the data receiver 11F2, and the data storage unit 11F3 are the same as those of the units that are explained by referring to FIG. 5.

The request reception unit 22F1 can receive a query as to whether there is a request from the relay server 22 to the file storage 23. The request reception unit 22F1 can be implemented by the communication I/F 11H4, for example.

The data determining unit 22F2 determines whether the relay server 22 stores data that is associated with ID of the file storage 23 from which the request reception unit 22F1 receives the query.

The data determining unit 22F1 can be implemented by the CPU 11H1, for example.

When the data determining unit 22F2 determines that the data is stored, the relay server 22 can transmit data by the data transmitter 11F1.

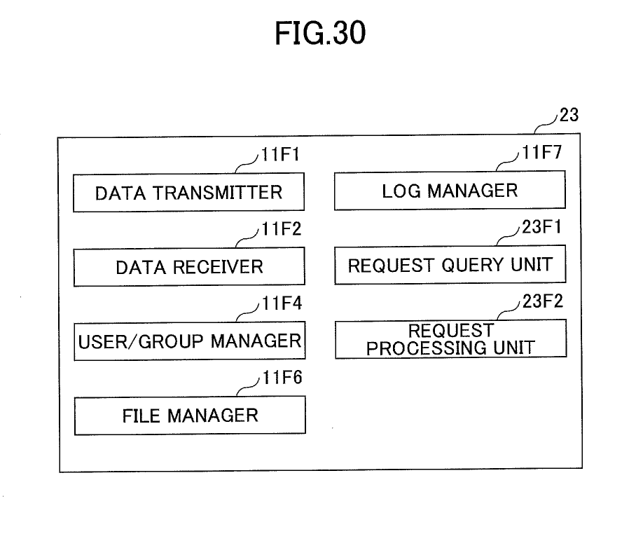

FIG. 30 is a functional block diagram showing an example of a functional configuration of the file storage 23 according to the embodiment of the present invention.

The file storage 23 can be implemented by the functional configuration that is depicted in FIG. 30, for example.

The file storage 23 may include a data transmitter 11F1; a data receiver 11F2; a user/group manager 11F4; a file manager 11F6; a log manager 11F7; a request query unit 23F1; and a request processing unit 23F2.

Functions of the data transmitter 11F1, the data receiver 11F2, the user/group manager 11F4, the file manager 11F6, and the log manager 11F7 are the same as those of the units that are explained by referring to FIG. 5.

The request query unit 23F1 can query the relay server 22 as to whether there is a request. The request query unit 23F1 can be implemented by the communication I/F 11H4, for example.

The request processing unit 23F2 can process a request based on a content of the request. The request processing unit 23F2 can be implemented by the CPU 11H1, for example.

Namely, the chat server 21, the relay server 22, and the file storage 23 according to this embodiment correspond to a case in which the functions of the above-described server 11 are distributed.

In the information processing system 20, each device can execute various types of processes and storing processes in a distributed manner, in parallel, or in a redundant manner. Further, in the information processing system 20, the security of the file that is stored in the file storage 23 can be enhanced compared to the above-described information processing system 1. In the information processing system 20, the first information processing terminal 10A and the second information processing terminal 10B can use a file that is stored in the file storage 23 because the relay device is used.

The first information processing terminal 10A and the second information processing terminal 10B can specify a file that is stored in the file storage 23 by the file specifying data. Upon the file that is stored in the file storage 23 being specified by the file specifying data, the relay server 22 can transmit a request to the file storage 23. Thus, the relay server 22 can receive the file that is specified by the file specifying data. The relay server 22 can cause the first information processing terminal 10A and the second information processing terminal 10B to retrieve the file that is specified by the file specifying data. As described above, the first information processing terminal 10A and the second information processing terminal 10B can use a file that is stored in the file storage 23 by using the relay server 22.

The embodiments are not limited to the case of implementation by the above-described information processing device. For example, the embodiments may be implemented by a program that is for causing an information processing device having a CPU or an information processing system having a CPU to execute various types of processing.

The information processing system and the information processing method are explained above by the embodiments. However, the present invention is not limited to the embodiments, and various modifications and improvements may be made within the scope of the present invention. Specific examples of numerical values are used in order to facilitate understanding of the invention. However, these numerical values are simply illustrative, and any other appropriate values may be used, except as indicated otherwise. The separations of the items in the above-described explanation are not essential to the present invention. Depending on necessity, subject matter described in two or more items may be combined and used, and subject matter described in an item may be applied to subject matter described in another item (provided that they do not contradict).

The present application is based on and claims the benefit of priority of Japanese priority application No. 2014-194029 filed on Sep. 24, 2014, the entire contents of which are hereby incorporated herein by reference.

What is claimed is:

1. An information processing system including at least a first information processing terminal; a second information processing terminal; and an information processing device that is connected to the first information processing terminal and to the second information processing terminal,
wherein the information processing system comprises:
a receiver configured to receive message data and file specifying data for specifying a file, the message data and the file specifying data being transmitted from the first information processing terminal and/or the second information processing terminal;
a storage unit configured to classify the file that is specified by the file specifying data based on access right data that represents access rights that are set for a user of the first information processing terminal and a user of the second information processing terminal, respectively, and classification data that represents classification, and configured to store the classified file; and
a transmitter configured to transmit, to the first information processing terminal or the second information processing terminal, the message data that is received by the receiver and message data that includes file storage data that represents the file that is stored in the storage unit.

2. The information processing system according to claim 1,
wherein the storage unit is configured to store, based on the access right data, the file that is specified by the file specifying data in a storage destination for which the user of the first information processing terminal and the user of the second information processing terminal have the access rights.

3. The information processing system according to claim 1,
wherein the file storage data is data that includes at least one of an access path to the file that is stored in the storage unit, a file name of the file that is stored in the storage unit, and information that represents a content of the file that is stored in the storage unit.

4. The information processing system according to claim 1,
wherein the classification data is data that includes at least one of date data that is included in the file that is specified by the file specifying data, user data that is included in the file that is specified by the file specifying data, extension data of the file that is specified by the file specifying data, keyword data that represents a content of the file that is specified by the file specifying data, location data of the first information processing terminal or the second information processing terminal, and similarity-degree data of the content of the file that is specified by the file specifying data.

5. The information processing system according to claim 1,
wherein the information processing system further includes a relay device configured to request, in response to being accessed by the first information processing terminal and/or the second information processing terminal, a file that is, stored in a storage destination that is configured to block access by the first information processing terminal and access by the second information processing terminal,
wherein, in response to detecting that the file specifying data specifies the file that is stored in the storage destination that is configured to block the access by the first information processing terminal and the access by the second information processing terminal, the relay device is configured to cause the information processing device to retrieve the file that is stored in the storage destination.

6. An information processing method that is to be executed by an information processing system including at least a first information processing terminal; a second information processing terminal; and an information processing devices that is connected to the first information processing terminal and to the second information processing terminal, the method comprising:
a receiving step of receiving, by the information processing device, message data and file specifying data for specifying a file, the message data and the file specifying data being transmitted from the first information processing terminal and/or the second information processing terminal;
a storing step, by the information processing device, of classifying the file that is specified by the file specifying data based on access right data that represents access rights that are set for a user of the first information processing terminal and a user of the second information processing terminal, respectively, and classification data that represents classification, and storing the classified file; and
a transmitting step, by the information processing device, of transmitting, to the first information processing terminal or the second information processing terminal, the message data that is received at the receiving step and message data that includes file storage data that represents the file that is stored at the storing step.
